(19) United States
(12) Patent Application Publication
(10) Pub. No.: US 2025/0243313 A1
(43) Pub. Date: Jul. 31, 2025

(54) POLYCAPROLACTONE POLYOLS, ELASTOMERS, AND METHODS OF MAKING AND USING THE SAME

(71) Applicant: INGEVITY UK LTD, Cheshire (GB)

(72) Inventors: Anthony Maher, Cheshire (GB); Norman W. Keane, Cheshire (GB); Joseph Scholes, Cheshire (GB)

(21) Appl. No.: 19/013,281

(22) Filed: Jan. 8, 2025

Related U.S. Application Data
(60) Provisional application No. 63/625,401, filed on Jan. 26, 2024.

(51) Int. Cl. C08G 18/42; C08G 18/32; C08G 18/76

(52) U.S. Cl. CPC C08G 18/4277; C08G 18/3206; C08G 18/7657

(57) ABSTRACT

Caprolactone polyols and polyurethane materials, prepolymers, and polyurethane elastomers including the same are described herein. The caprolactone polyol is made by a process including admixing caprolactone monomers and pentaspiroglycol (PSG) to form an initiator-caprolactone mixture or reaction mixture, adding one or more catalyst to the initiator-caprolactone mixture to form a reaction mixture, and polymerizing, such as ring opening polymerization, the caprolactone monomers in the reaction mixture, thereby forming the caprolactone polyol. The polyurethane elastomers includes a reaction product of one or more caprolactone polyol, optionally one or more additional polyol, and one or more isocyanate comprising two or more isocyanate groups. The polyurethane elastomers described herein have improved stain resistance, as compared to standard, commercially available polyols. Methods of making and using the caprolactone polyol and the prepolymer compositions, polyurethane materials, or polyurethane elastomers, as well as articles comprising or prepared from the same, are also described herein.

### CROSS-REFERENCE TO RELATED APPLICATIONS

The present application claims priority to, and the benefit of, U.S. Provisional Application No. 63/625,401, filed 26 Jan. 2024 and titled POLYCAPROLACTONE POLYOLS, ELASTOMERS, AND METHODS OF MAKING AND USING THE SAME, which is incorporated by reference herein in its entirety for all purposes.

### BACKGROUND OF THE INVENTION

### Field of the Discovery

The present disclosure relates to caprolactone polyols, polyurethane elastomers comprising caprolactone polyols of the present disclosure, and methods for preparing and using the caprolactone polyols and polyurethane elastomers comprising the same.

### Background Information

A polyurethane elastomer (also referred to as an elastomeric polyurethane) is formed by reacting a hydroxyl containing moiety (polyol) and an isocyanate functional material. The structure of the polyurethane elastomer is segmented and can be described in terms of a hard domain/segment that contains the isocyanate molecule and optionally a low molecular weight chain extender (e.g., a diol, diamine, or a combination thereof), and a soft domain/segment that contains the polyol—often a polyether, polyester, or a caprolactone-based polyol. Polyurethane elastomers can be used to produce a wide range of products/components as a true thermoset with an elastic nature, which provides polyurethane elastomers superior load-bearing, abrasion, and impact resistance.

There remains a need in the art for alternatives to polyester polyols and current caprolactone polyols that provide enhanced stain resistance. The present disclose describes novel caprolactone polyols that surprisingly and unexpectedly provides polyurethane elastomers with improved stain resistance, as compared to comparative commercial polyols. The present disclosure further provides polyurethane material and prepolymer(s) comprising the caprolactone polyols of the present disclosure, as well as methods of making and using the caprolactone polyols and polyurethane elastomers of the present disclosure and articles comprising or produced from the polyurethane elastomer of the present disclosure.

### SUMMARY

Presently described are pentaspiroglycol (PSG) initiated polyols, polyurethane materials comprising pentaspiroglycol (PSG) initiated polyols of the present disclosure, polyurethane elastomers pentaspiroglycol (PSG) initiated polyols of the present disclosure, and methods of their preparation and uses thereof.

Thus, in an aspect, the present disclosure relates to a polyurethane elastomer comprising a reaction product of: one or more (e.g., 1, 2, 3, 4, 5, or more) caprolactone polyol, one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), and optionally one or more (e.g., 1, 2, 3, 4, 5, or more) chain extender, wherein the caprolactone polyol is made by a process comprising: admixing caprolactone monomers and pentaspiroglycol (PSG) to form an initiator-caprolactone mixture or reaction mixture; adding one or more (e.g., 1, 2, 3, 4, 5, or more) catalyst (e.g., a tin-based catalyst (e.g., at least one of a stannous octoate catalyst, such as DABCO® T-9), a zinc-based catalyst, a zirconium-based catalyst, a titanium-based catalyst, or a combination thereof) to the initiator-caprolactone mixture to form a reaction mixture; and polymerizing (e.g., ring opening polymerization) the caprolactone monomers in the reaction mixture, thereby forming the caprolactone polyol.

Another aspect of the present disclosure relates to a method of making the polyurethane elastomer of the present disclosure. The method comprises reacting one or more (e.g., 1, 2, 3, 4, 5, or more) caprolactone polyol, optionally one or more (e.g., 1, 2, 3, 4, 5, or more) additional polyol, and one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), thereby forming a polyurethane material (e.g., a prepolymer composition or the polyurethane elastomer). In any aspect or embodiment described herein, the method of making the polyurethane elastomer further comprises adding to, and/or mixing with, the polyurethane material one or more (e.g., 1, 2, 3, 4, 5, or more) chain extender. In any aspect or embodiment described herein, the method of making the polyurethane elastomer further comprises molding the polyurethane elastomer (e.g., molding an article from the polyurethane elastomer, reaction injection molding, or a combination thereof).

A further aspect of the present disclosure relates to an article comprising, or produced from, the polyurethane elastomer of the present disclosure, or a polyurethane elastomer produced by the method of the present disclosure.

In any aspect or embodiment described herein, the process further comprises at least one of (i) sparging the initiator-caprolactone mixture prior to adding the one or more catalyst (e.g., sparging the initiator-caprolactone mixture with nitrogen); (ii) incubating the initiator-caprolactone mixture prior to adding the one or more catalyst (e.g., incubating for about 0.5 hours to about 1.5 hours, about 0.75 hours to about 1.25 hours, or about 1 hour, such as while sparking the initiator-caprolactone mixture), (iii) heating the initiator-caprolactone mixture to about 70° C. to about 100° C. (e.g., about 75° C. to about 95° C.), (iv) removing excess water from the initiator-caprolactone mixture, or (v) a combination thereof.

In any aspect or embodiment described herein, polymerizing comprises at least one of (i) performing with refluxing, (ii) performing at about 150° C. to about 190° C. (e.g., about 150° C. to about 180° C.), (iii) performing until the caprolactone monomer concentration is below 0.5%, (iv) performing for about 4 to about 6 hours, or (v) a combination thereof.

In any aspect or embodiment described herein, the process further comprises at least one of (i) adding one or more (e.g., 1, 2, 3, 4, 5, or more) acid scavengers (e.g., adding one or more acid scavenger after polymerizing, adding a sufficient amount of one or more acid scavenger to result in the caprolactone polyol having an acid number of <0.10 or <0.05 mgKOH/g, and/or the one or more acid scavenger includes or is at least one of monomeric carbodiimide, polymeric carbodiimide, or a combination thereof); (ii) adding additional catalyst (e.g., at least one of a tin-based catalyst (e.g., a stannous octoate catalyst, such as DABCO® T-9), a zinc-based catalyst, a zirconium-based catalyst, a titanium-based catalyst, or a combination thereof) to the reaction mixture (e.g., adding additional catalyst while heating the reaction mixture, such as to about 150° C. to about 190° C., such as about 150° C. to about 160° C.), thereby forming the caprolactone polyol; or (iii) a combination thereof.

In any aspect or embodiment described herein, the initiator-caprolactone mixture further comprises one or more (e.g., 1, 2, 3, 4, 5, or more) antioxidant and/or one or more (e.g., 1, 2, 3, 4, 5, or more) stabilizer (e.g., at least one of a phenolic antioxidant and/or stabilizer, a sterically hindered phenolic antioxidant and/or stabilizer, pentaerythritol tetrakis(3-(3,5-di-tert-butyl-4-hydroxyphenyl)propionate) (IRGANOX® 1010), a phosphite antioxidant and/or stabilizer, bis(2,4-di-tert-butylphenol)pentacrythritol diphosphate (e.g., IRGAFOS® 126), an antihydrolysis agent (STABAXOL® I), carbodiimide (e.g., monomeric carbodiimide), or a combination thereof).

In any aspect or embodiment described herein, at least one of (i) the caprolactone monomers are present in an amount of about 65 wt % to about 95 wt % (e.g., about 65 wt % to about 90 wt %, or about 65 wt % to about 85 wt %) of the initiator-caprolactone mixture; (ii) the pentaspiroglycol (PSG) is present in an amount of about 5 wt % to about 35 wt % (e.g., about 10 wt % to about 35 wt %, or about 15 wt % to about 35 wt %) of the initiator-caprolactone mixture; (iii) the caprolactone monomers is present in an amount of about 65 wt % to about 95 wt % (e.g., about 65 wt % to about 90 wt %, or about 65 wt % to about 85 wt %) of the reaction mixture; (iv) the pentaspiroglycol (PSG) is present in an amount of about 5 wt % to about 35 wt % (e.g., about 10 wt % to about 35 wt %, or about 15 wt % to about 35 wt %) of the reaction mixture; (v) the one or more catalyst is present in an amount of about 0.001 wt % to about 5 wt % (e.g., about 0.001 wt % to about 5 wt %, about 0.001 wt % to about 4 wt %, about 0.001 wt % to about 3 wt %, about 0.001 wt % to about 2 wt %, about 0.001 wt % to about 1 wt %, about 0.001 wt % to about 0.5 wt %, about 0.001 wt % to about 0.25 wt %, about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.1 wt % to about 0.25 wt %, about 0.2 wt % to about 5 wt %, about 0.2 wt % to about 4 wt %, about 0.2 wt % to about 3 wt %, about 0.2 wt % to about 2 wt %, about 0.2 wt % to about 1 wt %, about 0.2 wt % to about 0.5 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1 wt %, about 0.75 wt % to about 5 wt %, about 0.75 wt % to about 4 wt %, about 0.75 wt % to about 3 wt %, about 0.75 wt % to about 2 wt %, about 0.75 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 2 wt % to about 5 wt %, about 2 wt % to about 4 wt %, about 2 wt % to about 3 wt %, about 3 wt % to about 5 wt %, about 3 wt % to about 4 wt %, or about 4 wt % to about 5 wt %,) of the reaction mixture; (vi) the one or more antioxidants or stabilizer is present in an amount of up to about 2 wt % (e.g., up to about 1.5 wt %, up to about 1 wt %, up to about 0.5 wt %, up to about 0.25 wt %, about 0.1 wt % to about 2 wt %, about 0.1 wt % to about 1.5 wt %, about 0.1 wt % to about 1 wt %, about 0.1 wt % to about 0.75 wt %, about 0.1 wt % to about 0.5 wt %, or about 0.1 wt % to about 0.25 wt %) of the reaction mixture; or (vii) a combination thereof.

In any aspect or embodiment described herein, at least one of (i) the molecular weight of the caprolactone polyol is about 1,000 g/mol (MW) to about 4500 MW (e.g., about 1,000 MW to about 4,000 MW, about 1,000 MW to about 3,000 MW, about 1,000 MW to about 2,100 MW, or about 1,000 MW to about 2,000 MW); (ii) the caprolactone polyol comprises less than about 5% (e.g., less than about 4%, less than about 3%, less than about 2%, less than about 1%, less than about 0.5%, less than about 0.5%, less than about 0.25%, less than about 0.1%) caprolactone monomer; (iii) the caprolactone polyol has an acid number of <0.4 KOH/g (e.g., <0.3 KOH/g, <0.3 mgKOH/g, <0.2 KOH/g, <0.1 KOH/g, <0.75 KOH/g, <0.05 mgKOH/g); (iv) the one or more catalysts is one or more catalyst for ring-opening polymerization (e.g., at least one of zinc lactate, zinc oxide, zinc powder, diethyl zinc, tin lactate, tin oxide, tin dioxide, stannous oxide, stannous lactate, stannous octoate, stannous chloride, tin powder, propanoic acid or tetrabutyl titanate, or a combination thereof); or (v) a combination thereof.

In any aspect or embodiment described herein, the polyurethane elastomer is made by a process comprising reacting: (i) the one or more caprolactone polyol, (ii) optionally one or more (e.g., 1, 2, 3, 4, 5, or more) additional polyol, and (iii) the one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), thereby forming a polyurethane material (e.g., a prepolymer composition or the polyurethane elastomer).

In any aspect or embodiment described herein, at least one of (i) the process or method of making the polyurethane elastomer further comprises heating or melting the one or more isocyanate comprising two or more isocyanate groups (e.g., prior to adding the one or more one or more caprolactone polyol, and optionally the one or more additional polyol, heating the one or more isocyanate comprising two or more isocyanate groups to about 60° C. to about 100° C.), optionally under a nitrogen blanket; (ii) the process or method of making the polyurethane elastomer further comprises heating the one or more caprolactone polyol, optionally the one or more additional polyol, and the one or more isocyanate (e.g., heating to a temperature of about 60° C. to about 100° C., about 70° C. to about 90° C., about 75° C. to about 85° C., or about 80° C.); (iii) the process or method of making the polyurethane elastomer further comprises incubating or reacting the one or more caprolactone polyol, optionally the one or more additional polyol, and the one or more isocyanate for at least about 0.5 hours (e.g., about 0.5 to about 6.0 hours, about 0.5 to about 3.0 hours, or about 0.5 to about 2.0 hours, about 1.0 to about 1.5, or about 0.5 hours to about 1.0 hour); (iv) the process or method of making the polyurethane elastomer further comprises degassing the polyurethane material (e.g., the prepolymer composition or the polyurethane elastomer) under vacuum; (v) the polyurethane material has a NCO content of about 3.0% to about 15.0%, such as about 6.0% (e.g., as determined by American Society for Testing and Materials (ASTM) D5155-01—Standard Test Methods for Polyurethane Raw Materials Determination of the Isocyanate Content of Aromatic Isocyanates); or (vi) a combination thereof.

In any aspect or embodiment described herein, the process or method of making the polyurethane elastomer further comprises adding to, and/or mixing with, the polyurethane material one or more (e.g., 1, 2, 3, 4, 5, or more) chain extender (e.g., at least one of a diol (such as, a short-chain diol), a diamine, or a combination thereof), thereby forming the polyurethane elastomer.

In any aspect or embodiment described herein, at least one of (i) the one or more chain extender is added in an amount sufficient to achieve an isocyanate index of about 95 to about 107 (e.g., about 100 to 105 or 100); (ii) the one or more chain extender has a molecular weight from about 60 g/mol (MW) to about 600 g/mol (MW); (iii) the one or more chain extender includes or is one or more (e.g., 1, 2, 3, 4, 5, or more) diol chain extender, one or more (e.g., 1, 2, 3, 4, 5, or more) diamine chain extender; or (iv) a combination thereof.

In any aspect or embodiment described herein, the process or method of making the polyurethane elastomer further comprises molding the polyurethane elastomer (e.g., molding an article from the polyurethane elastomer, reaction injection molding, or a combination thereof).

In any aspect or embodiment described herein, molding the polyurethane elastomer comprises at least one of: (i) preheating a mold to about 80° C. to about 120° C.; (ii) adding the polyurethane elastomer to a mold; (iii) applying a releasing agent to a mold prior to adding the polyurethane elastomer; (iv) curing the polyurethane elastomer (1) in a mold at about 80° C. to about 120° C., (2) for about 16 hours, or (3) in a mold at about 80° C. to about 120° C. for about 16 hours; (v) conditioning a mold with the polyurethane elastomer (e.g., conditioning for a week at 50% relative humidity at 23° C.); or (vi) a combination thereof.

In any aspect or embodiment described herein, at least one of (i) the one or more additional polyol includes or is a low-molecular-weight polyol having a number average molecular weight of 400 or less; (ii) the one or more additional polyol has three or more hydroxyl groups; (iii) the one or more isocyanate includes or is at least one of monomeric, oligomeric, polymeric, or a mixture thereof; (iv) the one or more isocyanate includes or is at least one of an aliphatic polyisocyante, mono-cyclic polyisocyanate, aromatic polyisocyanates, aromatic/aliphatic polyisocyanate (e.g., tetramethylxylylene diisocyanate (TMXDI)), or a combination thereof; or (v) a combination thereof.

In any aspect or embodiment described herein, at least one of (i) the one or more additional polyol includes or is at least one of: one or more (e.g., 1, 2, 3, 4, 5, or more) trihydric alcohol (e.g., low-molecular-weight triol); one or more (e.g., 1, 2, 3, 4, 5, or more) tetrahydric alcohol (e.g., low-molecular-weight tetrol); one or more (e.g., 1, 2, 3, 4, 5, or more) pentahydric alcohol (e.g., low-molecular-weight pentol); one or more (e.g., 1, 2, 3, 4, 5, or more) hexahydric alcohol (e.g., a low-molecular-weight hexol); one or more (e.g., 1, 2, 3, 4, 5, or more) heptahydric alcohol (e.g., low-molecular-weight heptol); one or more (e.g., 1, 2, 3, 4, 5, or more) octahydric alcohol (e.g., low-molecular-weight octahydric alcohol); one or more (e.g., 1, 2, 3, 4, 5, or more) polyalkylene oxide having three or more hydroxyl groups (e.g., low-molecular weight polyalkylene oxide having three or more hydroxyl groups), or a combination thereof); or a combination thereof; (ii) the one or more isocyanate includes or is at least one of diphenylmethane diisocyanate, isophorone diisocyanate, bimethylene diisocyanate, trimethylene diisocyanate, tetramethylene diisocyanate, pentamethylene diisocyanate, hexamethylene diisocyanate, heptamethylene diisocyanate, toluene diisocyanate, naphthylene diisocyanate, cyclohexylmethane diisocyanate, dicyclohexylmethane diisocyanate, or a mixture thereof; (iii) the one or more chain extender includes or is a diol chain extender that includes or is an aliphatic diol or an aromatic diol; (iv) the one or more diol chain extender includes or is an at least one of alkylene oxide or glycol, ethylene glycol, propanediol, butanediol, pentadiol, hexanediol, heptadiol, dihydroxybenzene, di(hydroxyethyl)-hydroxyquinone, di(hydroxymethyl)-hydroxyquinone, di-(hydroxyethyl)-bisphenol A, or a mixture thereof; (v) the one or more diamine chain extender includes or is at least one of diaminodiphenylmethane, dichloro-diaminodiphenylmethane, diaminobenzene, dimethoxy-diamino biphenyl, dimethyl-diamino biphenyl, diamino biphenyl, dichloro-diamino biphenyl, or a mixture thereof; or (vi) a combination thereof.

In any aspect or embodiment described herein, at least one of (i) the one or more additional polyol includes or is incudes or is at least one of glycerin; 2-methyl-2-hydroxymethyl-1,3-propanediol; 2,4-dihydroxy-3-hydroxymethylpentane; 1,2,6-hexanetriol; trimethylolpropane; 2,2-bis(hydroxymethyl)-3-butanol; tetramethylolmethane (pentaerythritol); diglycerol; xylitol; sorbitol; mannitol; iditol; dulcitol; altritol; inositol; dipentaerythritol; perseitol; sucrose; polyethylenepolyol, polypropylenepolyol, polyethylenepolypropylenepolyol (such as a random copolymer or a block copolymer); or a combination thereof; (ii) the one or more isocyanate includes or is at least one of 1,3-trimethylene diisocyanate; 2,3-trimethylene diisocyanate; 1,2-trimethylene diisocyanate; 2,2-trimethylene diisocyanate; 1,4-tetramethylene diisocyanate; 1,3-tetramethylene diisocyanate; 1,2-tetramethylene diisocyanate; 2,3-tetramethylene diisocyanate; 1,1-tetramethylene diisocyanate; 2,2-tetramethylene diisocyanate; 1,5-pentamethylene diisocyanate; 1,4-pentamethylene diisocyanate; 1,3-pentamethylene diisocyanate; 1,2-pentamethylene diisocyanate; 2,3-pentamethylene diisocyanate; 2,4-pentamethylene diisocyanate; 3,4-pentamethylene diisocyanate; 3,5-pentamethylene diisocyanate; 1,1-pentamethylene diisocyanate; 2,2-pentamethylene diisocyanate; 3,3-pentamethylene diisocyanate; 1,6-hexamethylene diisocyanate; 1,5-hexamethylene diisocyanate; 1,4-hexamethylene diisocyanate; 1,3-hexamethylene diisocyanate; 1,2-hexamethylene diisocyanate; 2,3-hexamethylene diisocyanate; 2,4-hexamethylene diisocyanate; 2,5-hexamethylene diisocyanate; 3,4-hexamethylene diisocyanate; 3,5-hexamethylene diisocyanate; 4,5-hexamethylene diisocyanate; 1,1-hexamethylene diisocyanate; 2,2-hexamethylene diisocyanate; 3,3-hexamethylene diisocyanate; 1,7-heptamethylene diisocyanate; 1,6-heptamethylene diisocyanate; 1,5-heptamethylene diisocyanate; 1,4-heptamethylene diisocyanate; 1,3-heptamethylene diisocyanate; 1,2-heptamethylene diisocyanate; 2,3-heptamethylene diisocyanate; 2,4-heptamethylene diisocyanate; 2,5-heptamethylene diisocyanate; 2,6-heptamethylene diisocyanate; 3,3-heptamethylene diisocyanate; 3,4-heptamethylene diisocyanate; 1,1-heptamethylene diisocyanate; 2,2-heptamethylene diisocyanate; 3,3-heptamethylene diisocyanate; 4,4-heptamethylene diisocyanate; toluene-2,4-diisocyanate; toluene-2,6-diisocyanate; 1,2-naphthylene diisocyanate; 1,3-naphthylene diisocyanate; 1,4-naphthylene diisocyanate; 1,5-naphthylene diisocyanate; 1,6-naphthylene diisocyanate; 1,7-naphthylene diisocyanate; 1,8-naphthylene diisocyanate; 1,4-cyclohexylmethane diisocyanate; 2,4-cyclohexylmethane diisocyanate; 3,4-cyclohexylmethane diisocyanate; 4,4-cyclohexylmethane diisocyanate; 4,4′-dicyclohexylmethane diisocyanate; 1,4-dicyclohexylmethane diisocyanate; or a mixture thereof; (iii) the one or more isocyanate includes or is at least one of 2,2′-diphenylmethane diisocyanate; 2,4′-diphenylmethane diisocyanate; 4,4′-diphenylmethane diisocyanate (MDI); 3,3′-dimethyl-4,4′-biphenylene diisocyanate (TODI); a toluene diisocyanate (TDI); a polymeric MDI; a modified liquid 4,4′-diphenylmethane diisocyanate; hexamethylene-diisocyanate (“HDI”); 4,4′dicyclohexylmethane diisocyanate (“H₁₂ MDI”); isophorone diisocyanate (“IPDI”); para-phenylene diisocyanate (“PPDI”); meta-phenylene diisocyanate (“MPDI”); tetramethylene diisocyanate; dodecane diisocyanate; octamethylene diisocyanate; decamethylene diisocyanate; cyclobutane-1,3-diisocyanate; 1,2-cyclohexane diisocyanate; 1,3-cyclohexane diisocyanate; 1,4-cyclohexane diisocyanate; 2,4-methylcyclohexane diisocyanate; 2,6-methylcyclohexane diisocyanate; 4,4′-dicyclohexyldiisocyanate; 2,4′-dicyclohexyldiisocyanate; 1,3,5-cyclohexane triisocyanate; a isocyanate-methylcyclohexane isocyanate; a isocyanatocthylcyclohexane isocyanate; a bis(isocyanatomethyl)-cyclohexane diisocyanate; 4,4′-bis(isocyanatomethyl) dicyclohexane; 2,4′-bis(isocyanatomethyl) dicyclohexane; 2,4-hexahydrotoluenediisocyanate; 2,6-hexahydrotoluenediisocyanate; 1,2-phenylene diisocyanate; 1,3-phenylene diisocyanate; 1,4-phenylene diisocyanate; triphenyl methane-4,4′,4″-triisocyanate; naphthylene-1,5-diisocyanate; 2,4′-biphenyl diisocyanate; 4,4′-biphenyl diisocyanate; 2,2-biphenyl diisocyanate; a polyphenyl polymethylene polyisocyanate (“PMDI”); meta-tetramethylxylene diisocyanate (“m-TMXDI”); para-tetramethylxylene diisocyanate (“p-TMXDI”); or a mixture thereof; (iv) the one or more chain extender includes or is one or more (e.g., 1, 2, 3, 4, 5, or more) diol chain extender that includes or is at least one of 1,3-propanediol; 1,2-propanediol; 1,1-propanediol; 2,2-propanediol; 1,4-butanediol; 1,3-butanediol; 1,2-butanediol; 2,3-butanediol; 1,1-butanediol; 2,2-butanediol; 1,5-pentadiol; 1,4-pentadiol; 1,3-pentadiol; 1,2-pentadiol; 2,3-pentadiol; 2,4-pentadiol; 3,4-pentadiol; 3,5-hexanediol; 1,1-pentadiol; 2,2-pentadiol; 3,3-pentadiol; 1,6-hexanediol; 1,5-hexanediol; 1,4-hexanediol; 1,3-hexanediol; 1,2-hexanediol; 2,3-hexanediol; 2,4-hexanediol; 2,5-hexanediol; 3,4-hexanediol; 3,5-hexanediol; 4,5-hexanediol; 1,1-hexanediol; 2,2-hexanediol; 3,3-hexanediol; 1,7-heptadiol; 1,6-heptadiol; 1,5-heptadiol; 1,4-heptadiol; 1,3-heptadiol; 1,2-heptadiol; 2,3-heptadiol; 2,4-heptadiol; 2,5-heptadiol; 2, 6-heptadiol; 3,3-heptadiol; 3,4-heptadiol; 1,1-heptadiol; 2,2-heptadiol; 3,3-heptadiol; 4,4-heptadiol; 1,2-dihydroxybenzene; 1,3-dihydroxybenzene; 1,4-dihydroxybenzene; 1,4-di-(betahydroxyethyl)-hydroxyquinone; 2,5-di-(hydroxyethyl)-hydroxyquinone; 2,3-di-(hydroxyethyl)-hydroxyquinone; 3,5-di-(hydroxyethyl)-hydroxyquinone; 2,5-di-(hydroxyethyl)-hydroxyquinone; 2,3-di-(hydroxymethyl)-hydroxyquinone; 3,5-di-(hydroxymethyl)-hydroxyquinone; 1,4-di-(betahydroxyethyl)-bisphenol A; 1,3-di-(betahydroxyethyl)-bisphenol A; 1,2-di-(betahydroxyethyl)-bisphenol A; 1,5-di-(betahydroxyethyl)-bisphenol A; 2,3-di-(betahydroxyethyl)-bisphenol A; 2,4-di-(betahydroxyethyl)-bisphenol A; 2,5-di-(betahydroxyethyl)-bisphenol A; 2,6-di-(betahydroxyethyl)-bisphenol A; 3,4-di-(betahydroxyethyl)-bisphenol A; 3,5-di-(betahydroxyethyl)-bisphenol A; or a mixture thereof; (v) the one or more chain extender includes or is one or more (e.g., 1, 2, 3, 4, 5, or more) diamine chain extender that includes or is at least one of 2,2′-diaminodiphenylmethane; 2,3′-diaminodiphenylmethane; 2,4′-diaminodiphenylmethane; 2,5′-diaminodiphenylmethane; 2,6′-diaminodiphenylmethane; 3,4′-diaminodiphenylmethane; 3,5′-diaminodiphenylmethane; 3,6′-diaminodiphenylmethane; 4,4′-diaminodiphenylmethane; 4,5′-diaminodiphenylmethane; 4,6′-diaminodiphenylmethane; 5,6′-diaminodiphenylmethane; 2,2′-dichloro-3,3′-diaminodiphenylmethane; 2,2′-dichloro-4,4′-diaminodiphenylmethane; 5,5′-dichloro-3,3′-diaminodiphenylmethane; 2,2′-dichloro-6,6′-diaminodiphenylmethane; 2,2′-dichloro-3,4′-diaminodiphenylmethane; 2,2′-dichloro-3,5′-diaminodiphenylmethane; 2,2′-dichloro-3,6′-diaminodiphenylmethane; 2,2′-dichloro-4,5′-diaminodiphenylmethane; 2,2′-dichloro-4,6′-diaminodiphenylmethane; 2,2′-dichloro-5,6′-diaminodiphenylmethane; 3,3′-dichloro-2,2′-diaminodiphenylmethane; 3,3′-dichloro-4,4′-diaminodiphenylmethane; 3,3′-dichloro-5,5′-diaminodiphenylmethane; 3,3′-dichloro-6,6′-diaminodiphenylmethane; 3,3′-dichloro-2,5′-diaminodiphenylmethane; 3,3′-dichloro-4,5′-diaminodiphenylmethane; 3,3′-dichloro-6,5′-diaminodiphenylmethane; 3,3′-dichloro-4,2′-diaminodiphenylmethane; 3,3′-dichloro-4,6′-diaminodiphenylmethane; 4,4′-dichloro-2,2′-diaminodiphenylmethane; 4,4′-dichloro-3,3′-diaminodiphenylmethane; 4,4′-dichloro-5,5′-diaminodiphenylmethane; 4,4′-dichloro-6,6′-diaminodiphenylmethane; 4,4′-dichloro-2,3′-diaminodiphenylmethane; 4,4′-dichloro-2,5′-diaminodiphenylmethane; 4,4′-dichloro-2,6′-diaminodiphenylmethane; 4,4′-dichloro-3,5′-diaminodiphenylmethane; 4,4′-dichloro-3,6′-diaminodiphenylmethane; 4,4′-dichloro-5,6′-diaminodiphenylmethane; 5,5′-dichloro-2,2′-diaminodiphenylmethane; 5,5′-dichloro-3,3′-diaminodiphenylmethane; 5,5′-dichloro-4,4′-diaminodiphenylmethane; 5,5′-dichloro-6,6′-diaminodiphenylmethane; 5,5′-dichloro-2,3′-diaminodiphenylmethane; 5,5′-dichloro-2,4′-diaminodiphenylmethane; 5,5′-dichloro-2,6′-diaminodiphenylmethane; 5,5′-dichloro-3,4′-diaminodiphenylmethane; 5,5′-dichloro-3,6′-diaminodiphenylmethane; 5,5′-dichloro-4,6′-diaminodiphenylmethane; 6,6′-dichloro-2,2′-diaminodiphenylmethane; 6,6′-dichloro-3,3′-diaminodiphenylmethane; 6,6′-dichloro-4,4′-diaminodiphenylmethane; 6,6′-dichloro-5,5′-diaminodiphenylmethane; 6,6′-dichloro-2,3′-diaminodiphenylmethane; 6,6′-dichloro-2,4′-diaminodiphenylmethane; 6,6′-dichloro-2,5′-diaminodiphenylmethane; 6,6′-dichloro-3,4′-diaminodiphenylmethane; 6,6′-dichloro-3,5′-diaminodiphenylmethane; 6,6′-dichloro-4,5′-diaminodiphenylmethane; 1,4-diaminobenzene; 1,2-diaminobenzene; 1,3-diaminobenzene; 2,2′-dimethoxy-3,3′-diamino biphenyl; 2,2′-dimethoxy-4,4′-diamino biphenyl; 5,5′-dimethoxy-3,3′-diamino biphenyl; 2,2′-dimethoxy-6,6′-diamino biphenyl; 2,2′-dimethoxy-3,4′-diamino biphenyl; 2,2′-dimethoxy-3,5′-diamino biphenyl; 2,2′-dimethoxy-3,6′-diamino biphenyl; 2,2′-dimethoxy-4,5′-diamino biphenyl; 2,2′-dimethoxy-4,6′-diamino biphenyl; 2,2′-dimethoxy-5,6′-diamino biphenyl; 3,3′-dimethoxy-2,2′-diamino biphenyl; 3,3′-dimethoxy-4,4-diamino biphenyl; 3,3′-dimethoxy-5,5′-diamino biphenyl; 3,3′-dimethoxy-6,6′-diamino biphenyl; 3,3′-dimethoxy-2,5′-diamino biphenyl; 3,3′-dimethoxy-4,5′-diamino biphenyl; 3,3′-dimethoxy-6,5′-diamino biphenyl; 3,3′-dimethoxy-4,2′-diamino biphenyl; 3,3′-dimethoxy-4,6′-diamino biphenyl; 4,4′-dimethoxy-2,2′-diamino biphenyl; 4,4′-dimethoxy-3,3′-diamino biphenyl; 4,4′-dimethoxy-5,5′-diamino biphenyl; 4,4′-dimethoxy-6,6′-diamino biphenyl; 4,4′-dimethoxy-2,3′-diamino biphenyl; 4,4′-dimethoxy-2,5′-diamino biphenyl; 4,4′-dimethoxy-2,6′-diamino biphenyl; 4,4′-dimethoxy-3,5′-diamino biphenyl; 4,4′-dimethoxy-3,6′-diamino biphenyl; 4,4′-dimethoxy-5,6′-diamino biphenyl; 5,5′-dimethoxy-2,2′-diamino biphenyl; 5,5′-dimethoxy-3,3′-diamino biphenyl; 5,5′-dimethoxy-4,4′-diamino biphenyl; 5,5′-dimethoxy-6,6′-diamino biphenyl; 5,5′-dimethoxy-2,3′-diamino biphenyl; 5,5′-dimethoxy-2,4′-diamino biphenyl; 5,5′-dimethoxy-2,6′-diamino biphenyl; 5,5′-dimethoxy-3,4′-diamino biphenyl; 5,5′-dimethoxy-3,6′-diamino biphenyl; 5,5′-dimethoxy-4,6′-diamino biphenyl; 6,6′-dimethoxy-2,2′-diamino biphenyl; 6,6′-dimethoxy-3,3′-diamino biphenyl; 6,6′-dimethoxy-4,4′-diamino biphenyl; 6,6′-dimethoxy-5,5′-diamino biphenyl; 6,6′-dimethoxy-2,3′-diamino biphenyl; 6,6′-dimethoxy-2,4′-diamino biphenyl; 6,6′-dimethoxy-2,5′-diamino biphenyl; 6,6′-dimethoxy-3,4′-diamino biphenyl; 6,6′-dimethoxy-3,5′-diamino biphenyl; 6,6′-dimethoxy-4,5′-diamino biphenyl; 2,2′-dimethyl-3,3′-diamino biphenyl; 2,2′-dimethyl-4,4′-diamino biphenyl; 5,5′-dimethyl-3,3′-diamino biphenyl; 2,2′-dimethyl-6,6′-diamino biphenyl; 2,2′-dimethyl-3,4′-diamino biphenyl; 2,2′-dimethyl-3,5′-diamino biphenyl; 2,2′-dimethyl-3,6′-diamino biphenyl; 2,2′-dimethyl-4,5′-diamino biphenyl; 2,2′-dimethyl-4,6′-diamino biphenyl; 2,2′-dimethyl-5,6′-diamino biphenyl; 3,3′-dimethyl-2,2′-diamino biphenyl; 3,3′-dimethyl-4,4-diamino biphenyl; 3,3′-dimethyl-5,5′-diamino biphenyl; 3,3′-dimethyl-6,6′-diamino biphenyl; 3,3′-dimethyl-2,5′-diamino biphenyl; 3,3′-dimethyl-4,5′-diamino biphenyl; 3,3′-dimethyl-6,5′-diamino biphenyl; 3,3′-dimethyl-4,2′-diamino biphenyl; 3,3′-dimethyl-4,6′-diamino biphenyl; 4,4′-dimethyl-2,2′-diamino biphenyl; 4,4′-dimethyl-3,3′-diamino biphenyl; 4,4′-dimethyl-5,5′-diamino biphenyl; 4,4′-dimethyl-6,6′-diamino biphenyl; 4,4′-dimethyl-2,3′-diamino biphenyl; 4,4′-dimethyl-2,5′-diamino biphenyl; 4,4′-dimethyl-2,6′-diamino biphenyl; 4,4′-dimethyl-3,5′-diamino biphenyl; 4,4′-dimethyl-3,6′-diamino biphenyl; 4,4′-dimethyl-5,6′-diamino biphenyl; 5,5′-dimethyl-2,2′-diamino biphenyl; 5,5′-dimethyl-3,3′-diamino biphenyl; 5,5′-dimethyl-4,4′-diamino biphenyl; 5,5′-dimethyl-6,6′-diamino biphenyl; 5,5′-dimethyl-2,3′-diamino biphenyl; 5,5′-dimethyl-2,4′-diamino biphenyl; 5,5′-dimethyl-2,6′-diamino biphenyl; 5,5′-dimethyl-3,4′-diamino biphenyl; 5,5′-dimethyl-3,6′-diamino biphenyl; 5,5′-dimethyl-4,6′-diamino biphenyl; 6,6′-dimethyl-2,2′-diamino biphenyl; 6,6′-dimethyl-3,3′-diamino biphenyl; 6,6′-dimethyl-4,4′-diamino biphenyl; 6,6′-dimethyl-5,5′-diamino biphenyl; 6,6′-dimethyl-2,3′-diamino biphenyl; 6,6′-dimethyl-2,4′-diamino biphenyl; 6,6′-dimethyl-2,5′-diamino biphenyl; 6,6′-dimethyl-3,4′-diamino biphenyl; 6,6′-dimethyl-3,5′-diamino biphenyl; 6,6′-dimethyl-4,5′-diamino biphenyl; 2,2′-diamino biphenyl; 2,3′-diamino biphenyl; 2,4′-diamino biphenyl; 2,5′-diamino biphenyl; 2,6′-diamino biphenyl; 3,4′-diamino biphenyl; 3,5′-diamino biphenyl; 3,6′-diamino biphenyl; 4,4′-diamino biphenyl; 4,5′-diamino biphenyl; 4,6′-diamino biphenyl; 5,6′-diamino biphenyl; 2,2′-dichloro-3,3′-diamino biphenyl; 2,2′-dichloro-4,4′-diamino biphenyl; 5,5′-dichloro-3,3′-diamino biphenyl; 2,2′-dichloro-6,6′-diamino biphenyl; 2,2′-dichloro-3,4′-diamino biphenyl; 2,2′-dichloro-3,5′-diamino biphenyl; 2,2′-dichloro-3,6′-diamino biphenyl; 2,2′-dichloro-4,5′-diamino biphenyl; 2,2′-dichloro-4,6′-diamino biphenyl; 2,2′-dichloro-5,6′-diamino biphenyl; 3,3′-dichloro-2,2′-diamino biphenyl; 3,3′-dichloro-4,4′-diamino biphenyl; 3,3′-dichloro-5,5′-diamino biphenyl; 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl; 4,4′-dichloro-2,2′-diamino biphenyl; 4,4′-dichloro-3,3′-diamino biphenyl; 4,4′-dichloro-5,5′-diamino biphenyl; 4,4′-dichloro-6,6′-diamino biphenyl; 4,4′-dichloro-2,3′-diamino biphenyl; 4,4′-dichloro-2,5′-diamino biphenyl; 4,4′-dichloro-2,6′-diamino biphenyl; 4,4′-dichloro-3,5′-diamino biphenyl; 4,4′-dichloro-3,6′-diamino biphenyl; 4,4′-dichloro-5,6′-diamino biphenyl; 5,5′-dichloro-2,2′-diamino biphenyl; 5,5′-dichloro-3,3′-diamino biphenyl; 5,5′-dichloro-4,4′-diamino biphenyl; 5,5′-dichloro-6,6′-diamino biphenyl; 5,5′-dichloro-2,3′-diamino biphenyl; 5,5′-dichloro-2,4′-diamino biphenyl; 5,5′-dichloro-2,6′-diamino biphenyl; 5,5′-dichloro-3,4′-diamino biphenyl; 5,5′-dichloro-3,6′-diamino biphenyl; 5,5′-dichloro-4,6′-diamino biphenyl; 6,6′-dichloro-2,2′-diamino biphenyl; 6,6′-dichloro-3,3′-diamino biphenyl; 6,6′-dichloro-4,4′-diamino biphenyl; 6,6′-dichloro-5,5′-diamino biphenyl; 6,6′-dichloro-2,3′-diamino biphenyl; 6,6′-dichloro-2,4′-diamino biphenyl; 6,6′-dichloro-2,5′-diamino biphenyl; 6,6′-dichloro-3,4′-diamino biphenyl; 6,6′-dichloro-3,5′-diamino biphenyl; 6,6′-dichloro-4,5′-diamino biphenyl; or a mixture thereof; or (vi) a combination thereof.

In any aspect or embodiment described herein, at least one of (i) the one or more additional polyol includes or is at least one of N-butanol; ethylene glycol; 1,2-propanediol; 1,3-butanediol; 1,4-butanediol; 2,3-butanediol; 1,5-pentanediol; 1,6-hexanediol; neopentyl glycol; 1,4-dihydroxycyclohexane; 1,4-dimethylolcyclohexane; 1,8-octanediol; 1,10-decanediol; 1,12-dodecanediol; 1,4-cyclohexanediol; 1,4-cyclohexanedimethanol; N-substituted ethanolamine; glycerol; trimethylolpropane; trimethylolethane; pentaerythritol; or a combination thereof; (ii) the one or more isocyanate is at least one of 4,4′-diphenylmethane diisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof; (iii) the one or more chain extender includes or is diethylene triamine (DETA), ethylene diamine (EDA), meta-xylylenediamine (MXDA), aminoethyl ethanolamine (AEEA), 2-methyl pentane diamine, propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, hydrazine, substituted hydrazine, hydrazine reaction products, or a combination thereof; or (iv) a combination thereof.

In any aspect or embodiment described herein, at least one of (i) the one or more isocyanate includes or is 4,4′-diisocyanate dicyclohexylmethane; (ii) the one or more chain extender includes or is 1,4-butanediol; or (iii) a combination thereof.

In any aspect or embodiment described herein, at least one of (i) the polyurethane elastomer comprises a hardness of Shore Hardness A 25 to Shore Hardness of D 75; (ii) the polyurethane elastomer has a hard segment fraction (e.g., (i) the one or more isocyanate or (ii) the one or more isocyanate and the one or more chain extender) is about 0.20 to about 0.50 (e.g., about 0.25 to about 0.40 or about 0.32); or (iii) a combination thereof.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### DETAILED DESCRIPTION

The present disclosure will now be described more fully hereinafter, but not all embodiments of the disclosure are shown. While the disclosure has been described with reference to exemplary embodiments, it will be understood by those skilled in the art that various changes can be made and equivalents can be substituted for elements thereof without departing from the scope of the disclosure. In addition, many modifications can be made to adapt a particular structure or material to the teachings of the disclosure without departing from the essential scope thereof.

Where a range of values is provided, it is understood that each intervening value between the upper and lower limit of that range and any other stated or intervening value in that stated range is encompassed within the invention. The upper and lower limits of these smaller ranges can independently be included in the smaller ranges is also encompassed within the invention, subject to any specifically excluded limit in the stated range. Where the stated range includes one or both of the limits, ranges excluding either/or both of those included limits are also included in the present disclosure.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of’ or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that clements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of’ and “consisting essentially of’ shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

Surprisingly and unexpectedly, the inventors found that the caprolactone polyols of the present disclosure can be used in polyurethane elastomer that have improved stain resistance, as compared to standard, commercially available polyols. In any aspect or embodiment described herein, the caprolactone polyol is made by a process comprising: admixing caprolactone monomers and pentaspiroglycol (PSG) to form an initiator-caprolactone mixture or reaction mixture; adding one or more (e.g., 1, 2, 3, 4, 5, or more) catalyst (e.g., at least one of a tin-based catalyst (e.g., a stannous octoate catalyst, such as DABCO® T-9), a zinc-based catalyst, a zirconium-based catalyst, a titanium-based catalyst, or a combination thereof) to the initiator-caprolactone mixture to form a reaction mixture; and polymerizing (e.g., ring opening polymerization) the caprolactone monomers in the reaction mixture, thereby forming the caprolactone polyol.

### Caprolactone Polyols of the Disclosure and Methods of Making the Same

An aspect of the present disclosure relates to a caprolactone polyol made by a process comprising: admixing caprolactone monomers and pentaspiroglycol (PSG) to form an initiator-caprolactone mixture or reaction mixture; adding one or more (e.g., 1, 2, 3, 4, 5, or more) catalyst (e.g., a tin-based catalyst (e.g., at least one of a stannous octoate catalyst, such as DABCO® T-9), a zinc-based catalyst, a zirconium-based catalyst, a titanium-based catalyst, or a combination thereof) to the initiator-caprolactone mixture to form a reaction mixture; and polymerizing (e.g., ring opening polymerization) the caprolactone monomers in the reaction mixture, thereby forming the caprolactone polyol.

Another aspect of the present disclosure relates to a method of making the caprolactone polyol of the present disclosure. The method comprises, consisting essentially or, or consisting of, admixing caprolactone monomers and pentaspiroglycol (PSG) to form an initiator-caprolactone mixture or reaction mixture; adding one or more (e.g., 1, 2, 3, 4, 5, or more) catalyst (e.g., a tin-based catalyst (e.g., at least one of a stannous octoate catalyst, such as DABCO® T-9), a zinc-based catalyst, a zirconium-based catalyst, a titanium-based catalyst, or a combination thereof) to the initiator-caprolactone mixture to form a reaction mixture; and polymerizing (e.g., ring opening polymerization) the caprolactone monomers in the reaction mixture, thereby forming the caprolactone polyol.

In any aspect or embodiment described herein, the process further comprises at least one of (i) sparging the initiator-caprolactone mixture prior to adding the one or more catalyst (e.g., sparging the initiator-caprolactone mixture with nitrogen); (ii) incubating the initiator-caprolactone mixture prior to adding the one or more catalyst (e.g., incubating for about 0.5 hours to about 1.5 hours, about 0.75 hours to about 1.25 hours, or about 1 hour, such as while sparking the initiator-caprolactone mixture), (iii) heating the initiator-caprolactone mixture to about 70° C. to about 100° C. (e.g., about 75° C. to about 95° C.), (iv) removing excess water from the initiator-caprolactone mixture, or (v) a combination thereof.

In any aspect or embodiment described herein, polymerizing was performed (i) with refluxing, (ii) at about 150° C. to about 190° C. (e.g., about 150° C. to about 180° C.), (iii) until the caprolactone monomer concentration is below 0.5%; (iv) for about 4 to about 6 hours, or (v) a combination thereof. For example, in any aspect or embodiment described herein, polymerizing comprises at least one of (i) performing with refluxing, (ii) performing at about 150° C. to about 190° C. (e.g., about 150° C. to about 180° C.), (iii) performing until the caprolactone monomer concentration is below 0.5%; (iv) performing for about 4 to about 6 hours, or (v) a combination thereof.

In any aspect or embodiment described herein, the process further comprises at least one of (i) adding one or more (e.g., 1, 2, 3, 4, 5, or more) acid scavengers (e.g., adding one or more acid scavenger after polymerizing, adding a sufficient amount of one or more acid scavenger to result in the caprolactone polyol having an acid number of <0.10 or <0.05 mgKOH/g, and/or the one or more acid scavenger includes or is at least one of monomeric carbodiimide, polymeric carbodiimide, or a combination thereof); (ii) adding additional catalyst (e.g., a tin-based catalyst (e.g., at least one of a stannous octoate catalyst, such as DABCO® T-9), a zinc-based catalyst, a zirconium-based catalyst, a titanium-based catalyst, or a combination thereof) to the reaction mixture (e.g., adding additional catalyst while heating the reaction mixture, such as to about 150° C. to about 190° C., such as about 150° C. to about 160° C.), thereby forming the caprolactone polyol; or (iii) a combination thereof. For example, in any aspect or embodiment described herein, the one or more acid scavenger includes or is at least one of monomeric carbodiimide (e.g., at least one of STABAXOL® I (LANXESS, Cologne, Germany), Stabilizer 7000A (bis(2,6-diisopropylphenyl) carbodiimide, or a combination thereof), polymeric carbodiimide (e.g., at least one of LUBIO® AS 15 (Schäfer-Additivsysteme GmbH, Rhein Germany), LUBIO® AS 11 (Schäfer-Additivsysteme GmbH, Rhein Germany), LUBIO® Hydrostab 2 (Schäfer-Additivsysteme GmbH, Rhein Germany), LUBIO® Hydrostab 3 (Schäfer-Additivsysteme GmbH, Rhein Germany), LUBIO® Hydrostab 4 (Schäfer-Additivsysteme GmbH, Rhein Germany), LUBIO® Hydrostab 5 (Schäfer-Additivsysteme GmbH, Rhein Germany), LUBIO® Hydrostab 6 (Schäfer-Additivsysteme GmbH, Rhein Germany), STABAXOL® P200 (LANXESS, Cologne, Germany), or a combination thereof), or a combination thereof.

In any aspect or embodiment described herein, the initiator-caprolactone mixture further comprises one or more (e.g., 1, 2, 3, 4, 5, or more) antioxidant and/or one or more (e.g., 1, 2, 3, 4, 5, or more) stabilizer (e.g., at least one of a phenolic antioxidant and/or stabilizer, a sterically hindered phenolic antioxidant and/or stabilizer, pentaerythritol tetrakis (3-(3,5-di-tert-butyl-4-hydroxyphenyl)propionate) (IRGANOX® 1010), a phosphite antioxidant and/or stabilizer, bis(2,4-di-tert-butylphenol)pentaerythritol diphosphate (e.g., IRGAFOS® 126), an antihydrolysis agent (STABAXOL® I), carbodiimide (e.g., monomeric carbodiimide), or a combination thereof).

In any aspect or embodiment described herein, at least one of (i) the caprolactone monomers is present in an amount of about 65 wt % to about 95 wt % (e.g., about 65 wt % to about 90 wt %, or about 65 wt % to about 85 wt %) of the initiator-caprolactone mixture; (ii) the pentaspiroglycol (PSG) is present in an amount of about 5 wt % to about 35 wt % (e.g., about 10 wt % to about 35 wt %, or about 15 wt % to about 35 wt %) of the initiator-caprolactone mixture; (iii) the caprolactone monomers is present in an amount of about 65 wt % to about 95 wt % (e.g., about 65 wt % to about 90 wt %, or about 65 wt % to about 85 wt %) of the reaction mixture; (iv) the pentaspiroglycol (PSG) is present in an amount of about 5 wt % to about 35 wt % (e.g., about 10 wt % to about 35 wt %, or about 15 wt % to about 35 wt %) of the reaction mixture; (v) the one or more catalyst is present in an amount of about 0.001 wt % to about 5 wt % (e.g., about 0.001 wt % to about 5 wt %, about 0.001 wt % to about 4 wt %, about 0.001 wt % to about 3 wt %, about 0.001 wt % to about 2 wt %, about 0.001 wt % to about 1 wt %, about 0.001 wt % to about 0.5 wt %, about 0.001 wt % to about 0.25 wt %, about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.1 wt % to about 0.25 wt %, about 0.2 wt % to about 5 wt %, about 0.2 wt % to about 4 wt %, about 0.2 wt % to about 3 wt %, about 0.2 wt % to about 2 wt %, about 0.2 wt % to about 1 wt %, about 0.2 wt % to about 0.5 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1 wt %, about 0.75 wt % to about 5 wt %, about 0.75 wt % to about 4 wt %, about 0.75 wt % to about 3 wt %, about 0.75 wt % to about 2 wt %, about 0.75 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 2 wt % to about 5 wt %, about 2 wt % to about 4 wt %, about 2 wt % to about 3 wt %, about 3 wt % to about 5 wt %, about 3 wt % to about 4 wt %, or about 4 wt % to about 5 wt %,) of the reaction mixture; (vi) the one or more antioxidants or stabilizer is present in an amount of up to about 2 wt % (e.g., up to about 1.5 wt %, up to about 1 wt %, up to about 0.5 wt %, up to about 0.25 wt %, about 0.1 wt % to about 2 wt %, about 0.1 wt % to about 1.5 wt %, about 0.1 wt % to about 1 wt %, about 0.1 wt % to about 0.75 wt %, about 0.1 wt % to about 0.5 wt %, or about 0.1 wt % to about 0.25 wt %) of the reaction mixture; or (vii) a combination thereof.

In any aspect or embodiment described herein, at least one of (i) the molecular weight of the caprolactone polyol is about 1,000 g/mol (MW) to about 4500 MW (e.g., about 1,000 MW to about 4,000 MW, about 1,000 MW to about 3,000 MW, about 1,000 MW to about 2,100 MW, or about 1,000 MW to about 2,000 MW); (ii) the caprolactone polyol comprises less than about 5% (e.g., less than about 4%, less than about 3%, less than about 2%, less than about 1%, less than about 0.5%, less than about 0.5%, less than about 0.25%, less than about 0.1%) caprolactone monomer; (iii) the caprolactone polyol has an acid number of <0.4 KOH/g (e.g., <0.3 KOH/g, <0.3 mgKOH/g, <0.2 KOH/g, <0.1 KOH/g, <0.75 KOH/g, <0.05 mgKOH/g); (iv) the one or more catalysts is one or more catalyst for ring-opening polymerization (e.g., at least one of zinc lactate, zinc oxide, zinc powder, diethyl zinc, tin lactate, tin oxide, tin dioxide, stannous oxide, stannous lactate, stannous octoate, stannous chloride, tin powder, propanoic acid or tetrabutyl titanate, or a combination thereof); or (v) a combination thereof.

As used herein, the term “caprolactone” is intended to encompass unsubstituted caprolactone and substituted caprolactone. The term “ε-caprolactone” is intended to encompass unsubstituted ε-caprolactone and substituted ε-caprolactone. Unsubstituted ε-caprolactone is particularly preferred.

In any aspect or embodiment described herein, polymerization may include the polymerization of caprolactone, particularly ε-caprolactone, with a mixture of different caprolactones, for example, substituted and unsubstituted caprolactones or a mixture of caprolactones having different substituents.

In any aspect or embodiment described herein, substituted ε-caprolactone monomers that may be used in the production of the caprolactone polyols include C₁₋₁₂ alkyl substituted ε-caprolactone, C₁₋₁₂ alkenyl substituted ε-caprolactone, C₁₋₁₂ alkynyl substituted ε-caprolactone, C₁₋₁₈ cycloalkyl substituted ε-caprolactone, C₁₋₁₂ alkoxy substituted ε-caprolactone, C₁₋₁₈ aryl substituted ε-caprolactone, C₁₋₁₈ alkaryl substituted ε-caprolactone, C₁₋₁₈ aralkyl substituted ε-caprolactone, C₁₋₁₈ aryloxy substituted ε-caprolactone, and mixtures thereof.

In any aspect or embodiment described herein, substituted ε-caprolactone monomers that may be used in the production of the auxiliary caprolactone polyols include mono-, di- or tri-substituted monomers. In any aspect or embodiment described herein, exemplary substituted ε-caprolactone monomers include at least one of monomethyl ε-caprolactone, monoethyl ε-caprolactone, monopropyl ε-caprolactone, monomethoxy ε-caprolactone, monoethoxy ε-caprolactone, monopropoxy ε-caprolactone, monobenzyl ε-caprolactone, monophenyl ε-caprolactone, dimethyl ε-caprolactone, diethyl ε-caprolactone, dipropyl ε-caprolactone, dimethoxy ε-caprolactone, diethoxy ε-caprolactone, dipropoxy ε-caprolactone, dibenzyl ε-caprolactone, diphenyl ε-caprolactone, and mixtures thereof.

### Polyurethane Elastomer of the Disclosure and Methods of Making the Same

A further aspect of the present disclosure relates to a polyurethane elastomer comprising one or more (e.g., 1, 2, 3, 4, 5, or more) caprolactone polyol of the present disclosure.

Another aspect of the present disclosure relates to a polyurethane elastomer comprising a reaction product of: one or more (e.g., 1, 2, 3, 4, 5, or more) caprolactone polyol of the present disclosure, one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), and optionally one or more (e.g., 1, 2, 3, 4, 5, or more) chain extender.

An aspect of the present disclosure relates to a polyurethane elastomer comprising a reaction product of: one or more (e.g., 1, 2, 3, 4, 5, or more) caprolactone polyol, one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), and optionally one or more (e.g., 1, 2, 3, 4, 5, or more) chain extender, wherein the caprolactone polyol is made by a process comprising: admixing caprolactone monomers and pentaspiroglycol (PSG) to form an initiator-caprolactone mixture or reaction mixture; adding one or more (e.g., 1, 2, 3, 4, 5, or more) catalyst (e.g., a tin-based catalyst (e.g., at least one of a stannous octoate catalyst, such as DABCO® T-9), a zinc-based catalyst, a zirconium-based catalyst, a titanium-based catalyst, or a combination thereof) to the initiator-caprolactone mixture to form a reaction mixture; and polymerizing (e.g., ring opening polymerization) the caprolactone monomers in the reaction mixture, thereby forming the caprolactone polyol.

An additional aspect of the present disclosure relates to a method of making the polyurethane clastomer of the present disclosure. The method comprises reacting one or more (e.g., 1, 2, 3, 4, 5, or more) caprolactone polyol of the present disclosure, optionally one or more (e.g., 1, 2, 3, 4, 5, or more) additional polyol, and one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), thereby forming a polyurethane material (e.g., a prepolymer composition or the polyurethane elastomer). In any aspect or embodiment described herein, the method of making the polyurethane elastomer further comprises adding to, and/or mixing with, the polyurethane material one or more (e.g., 1, 2, 3, 4, 5, or more) chain extender. In any aspect or embodiment described herein, the method of making the polyurethane elastomer further comprises molding the polyurethane elastomer (e.g., molding an article from the polyurethane elastomer, reaction injection molding, or a combination thereof).

In any aspect or embodiment described herein, the polyurethane elastomer is made by a process comprising reacting: (i) the one or more caprolactone polyol, (ii) optionally one or more (e.g., 1, 2, 3, 4, 5, or more) additional polyol, and (iii) the one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), thereby forming a polyurethane material (e.g., a prepolymer composition or the polyurethane elastomer).

In any aspect or embodiment described herein, the process or method of making the polyurethane elastomer further comprises heating or melting the one or more isocyanate comprising two or more isocyanate groups (e.g., prior to adding the one or more one or more caprolactone polyol, and optionally the one or more additional polyol, heating the one or more isocyanate comprising two or more isocyanate groups to about 60° C. to about 100° C.), optionally under a nitrogen blanket. Thus, in any aspect or embodiment described herein, the process or method of making the polyurethane elastomer further comprises heating or melting the one or more isocyanate comprising two or more isocyanate groups under a nitrogen blanket. For example, in any aspect or embodiment described herein, the process or method of making the polyurethane elastomer further comprises heating or melting the one or more isocyanate to or at a temperature of the process or method of making the polyurethane elastomer further comprises heating or melting the one or more isocyanate comprising two or more isocyanate groups (e.g., prior to adding the one or more one or more caprolactone polyol, and optionally the one or more additional polyol, heating the one or more isocyanate comprising two or more isocyanate groups to about 60° C. to about 100° C., about 60° C. to about 95° C., about 60° C. to about 90° C., about 60° C. to about 85° C., about 60° C. to about 80° C., about 60° C. to about 75° C., about 60° C. to about 70° C., about 60° C. to about 65° C., about 65° C. to about 100° C., about 65° C. to about 95° C., about 65° C. to about 90° C., about 65° C. to about 85° C., about 65° C. to about 80° C., about 65° C. to about 75° C., about 65° C. to about 70° C., about 70° C. to about 100° C., about 70° C. to about 95° C., about 70° C. to about 90° C., about 70° C. to about 85° C., about 70° C. to about 80° C., about 70° C. to about 75° C., about 75° C. to about 100° C., about 75° C. to about 95° C., about 75° C. to about 90° C., about 75° C. to about 85° C., about 75° C. to about 80° C., about 80° C. to about 100° C., about 80° C. to about 95° C., about 80° C. to about 90° C., about 80° C. to about 85° C., about 85° C. to about 100° C., about 85° C. to about 95° C., about 85° C. to about 90° C., about 90° C. to about 100° C., about 90° C. to about 95° C., or about 90° C. to about 100° C.

In any aspect or embodiment described herein, the process or method of making the polyurethane elastomer further comprises heating the one or more caprolactone polyol, optionally the one or more additional polyol, and the one or more isocyanate (e.g., heating to a temperature of about 60° C. to about 100° C., about 70° C. to about 90° C., about 75° C. to about 85° C., or about 80° C.). For example, in any aspect or embodiment described herein, the process or method of making the polyurethane elastomer further comprises heating the one or more caprolactone polyol, optionally the one or more additional polyol, and the one or more isocyanate to a temperature of about 60° C. to about 100° C., about 60° C. to about 95° C., about 60° C. to about 90° C., about 60° C. to about 85° C., about 60° C. to about 80° C., about 60° C. to about 75° C., about 60° C. to about 70° C., about 60° C. to about 65° C., about 65° C. to about 100° C., about 65° C. to about 95° C., about 65° C. to about 90° C., about 65° C. to about 85° C., about 65° C. to about 80° C., about 65° C. to about 75° C., about 65° C. to about 70° C., about 70° C. to about 100° C., about 70° C. to about 95° C., about 70° C. to about 90° C., about 70° C. to about 85° C., about 70° C. to about 80° C., about 70° C. to about 75° C., about 75° C. to about 100° C., about 75° C. to about 95° C., about 75° C. to about 90° C., about 75° C. to about 85° C., about 75° C. to about 80° C., about 80° C. to about 100° C., about 80° C. to about 95° C., about 80° C. to about 90° C., about 80° C. to about 85° C., about 85° C. to about 100° C., about 85° C. to about 95° C., about 85° C. to about 90° C., about 90° C. to about 100° C., about 90° C. to about 95° C., or about 90° C. to about 100° C.

In any aspect or embodiment described herein, the process or method of making the polyurethane elastomer further comprises incubating or reacting the one or more caprolactone polyol, optionally the one or more additional polyol, and the one or more isocyanate for at least 0.5 hours. For example, in any aspect or embodiment described herein, the process or method of making the polyurethane elastomer further comprises incubating or reacting the one or more caprolactone polyol, optionally the one or more additional polyol, and the one or more isocyanate for about 0.5 to about 6.0 hours, about 0.5 to about 3.0 hours, or about 0.5 to about 2.0 hours, about 1.0 to about 1.5, or about 0.5 hours to about 1.0 hour.

In any aspect or embodiment described herein, the process or method of making the polyurethane elastomer further comprises degassing the polyurethane material (e.g., the prepolymer composition or the polyurethane elastomer) under vacuum.

In any aspect or embodiment described herein, the polyurethane material (e.g., prepolymer) has a NCO content of about 3.0% to about 15.0%, such as about 6.0%. In any aspect or embodiment described herein, the NCO content is determined by American Society for Testing and Materials (ASTM) D5155-01—Standard Test Methods for Polyurethane Raw Materials Determination of the Isocyanate Content of Aromatic Isocyanates. For example, in any aspect or embodiment described herein, the polyurethane material (e.g., prepolymer) has a NCO content of about 3.0% to about 15.0%, about 3.0% to about 14.0%, about 3.0% to about 13.0%, about 3.0% to about 12.0%, about 3.0% to about 11.0%, about 3.0% to about 10.0%, about 3.0% to about 9.0%, about 3.0% to about 8.0%, about 3.0% to about 7.0%, about 3.0% to about 6.0%, about 3.0% to about 5.0%, about 4.0% to about 15.0%, about 4.0% to about 14.0%, about 4.0% to about 13.0%, about 4.0% to about 12.0%, about 4.0% to about 11.0%, about 4.0% to about 10.0%, about 4.0% to about 9.0%, about 4.0% to about 8.0%, about 4.0% to about 7.0%, about 4.0% to about 6.0%, about 5.0% to about 15.0%, about 5.0% to about 14.0%, about 5.0% to about 13.0%, about 5.0% to about 12.0%, about 5.0% to about 11.0%, about 5.0% to about 10.0%, about 5.0% to about 9.0%, about 5.0% to about 8.0%, about 5.0% to about 7.0%, about 6.0% to about 15.0%, about 6.0% to about 14.0%, about 6.0% to about 13.0%, about 6.0% to about 12.0%, about 6.0% to about 11.0%, about 6.0% to about 10.0%, about 6.0% to about 9.0%, about 6.0% to about 8.0%, about 7.0% to about 15.0%, about 7.0% to about 14.0%, about 7.0% to about 13.0%, about 7.0% to about 12.0%, about 7.0% to about 11.0%, about 7.0% to about 10.0%, about 7.0% to about 9.0%, about 8.0% to about 15.0%, about 8.0% to about 14.0%, about 8.0% to about 13.0%, about 8.0% to about 12.0%, about 8.0% to about 11.0%, about 8.0% to about 10.0%, about 9.0% to about 15.0%, about 9.0% to about 14.0%, about 9.0% to about 13.0%, about 9.0% to about 12.0%, about 9.0% to about 11.0%, about 10.0% to about 15.0%, about 10.0% to about 14.0%, about 10.0% to about 13.0%, about 10.0% to about 12.0%, about 11.0% to about 15.0%, about 11.0% to about 14.0%, about 11.0% to about 13.0%, about 12.0% to about 15.0%, about 12.0% to about 14.0%, about 12.0% to about 13.0%, about 13.0% to about 15.0%, or about 13.0% to about 14.0%, about 14.0% to about 15.0%.

In any aspect or embodiment described herein, the process or method of making the polyurethane elastomer further comprises adding to, and/or mixing with, the polyurethane material one or more (e.g., 1, 2, 3, 4, 5, or more) chain extender (e.g., at least one of a diol (such as, a short-chain diol), a diamine, or a combination thereof), thereby forming the polyurethane elastomer.

In any aspect or embodiment described herein, the one or more chain extender is added in an amount sufficient to achieve an isocyanate index of about 95 to about 107 (e.g., about 100 to 105 or 100). For example, the one or more chain extender is added in an amount sufficient to achieve an isocyanate index of about 95 to about 107, about 95 to about 106, about 95 to about 105, about 95 to about 104, about 95 to about 103, about 95 to about 102, about 95 to about 101, about 95 to about 100, about 95 to about 99, about 95 to about 98, about 95 to about 97, about 96 to about 107, about 96 to about 106, about 96 to about 105, about 96 to about 104, about 96 to about 103, about 96 to about 102, about 96 to about 101, about 96 to about 100, about 96 to about 99, about 96 to about 98, about 97 to about 107, about 97 to about 106, about 97 to about 105, about 97 to about 104, about 97 to about 103, about 97 to about 102, about 97 to about 101, about 97 to about 100, about 97 to about 99, about 98 to about 107, about 98 to about 106, about 98 to about 105, about 98 to about 104, about 98 to about 103, about 98 to about 102, about 98 to about 101, about 98 to about 100, about 99 to about 107, about 99 to about 106, about 99 to about 105, about 99 to about 104, about 99 to about 103, about 99 to about 102, about 99 to about 101, about 100 to about 107, about 100 to about 106, about 100 to about 105, about 100 to about 104, about 100 to about 103, about 100 to about 102, about 101 to about 107, about 101 to about 106, about 101 to about 105, about 101 to about 104, about 101 to about 103, about 102 to about 107, about 102 to about 106, about 102 to about 105, about 102 to about 104, about 103 to about 107, about 103 to about 106, about 103 to about 105, about 104 to about 107, about 105 to about 106, or about 105 to about 107.

In any aspect or embodiment described herein, the one or more chain extender has a molecular weight from about 60 g/mol (MW) to about 600 g/mol (MW). For example, in any aspect or embodiment described herein, the one or more chain extender has a molecular weight from about 60 g/mol (MW) to about 600 MW, about 60 MW to about 550 MW, about 60 MW to about 500 MW, about 60 MW to about 450 MW, about 60 MW to about 400 MW, about 60 MW to about 350 MW, about 60 MW to about 300 MW, about 60 MW to about 250 MW, about 60 MW to about 200 MW, about 60 MW to about 150 MW, about 100 MW to about 600 MW, about 100 MW to about 550 MW, about 100 MW to about 500 MW, about 100 MW to about 450 MW, about 100 MW to about 400 MW, about 100 MW to about 350 MW, about 100 MW to about 300 MW, about 100 MW to about 250 MW, about 100 MW to about 200 MW, about 150 MW to about 600 MW, about 150 MW to about 550 MW, about 150 MW to about 500 MW, about 150 MW to about 450 MW, about 150 MW to about 400 MW, about 150 MW to about 350 MW, about 150 MW to about 300 MW, about 150 MW to about 250 MW, about 200 MW to about 600 MW, about 200 MW to about 550 MW, about 200 MW to about 500 MW, about 200 MW to about 450 MW, about 200 MW to about 400 MW, about 200 MW to about 350 MW, about 200 MW to about 300 MW, about 250 MW to about 600 MW, about 250 MW to about 550 MW, about 250 MW to about 500 MW, about 250 MW to about 450 MW, about 250 MW to about 400 MW, about 250 MW to about 350 MW, about 300 MW to about 600 MW, about 300 MW to about 550 MW, about 300 MW to about 500 MW, about 300 MW to about 450 MW, about 300 MW to about 400 MW, about 300 MW to about 600 MW, about 300 MW to about 550 MW, about 300 MW to about 500 MW, about 300 MW to about 450 MW, about 300 MW to about 400 MW, about 350 MW to about 600 MW, about 350 MW to about 550 MW, about 350 MW to about 500 MW, about 350 MW to about 450 MW, about 400 MW to about 600 MW, about 400 MW to about 550 MW, about 400 MW to about 500 MW, about 450 MW to about 600 MW, about 450 MW to about 550 MW, or about 500 MW to about 600 MW.

In any aspect or embodiment described herein, the one or more chain extender includes or is one or more (e.g., 1, 2, 3, 4, 5, or more) diol chain extender, one or more (e.g., 1, 2, 3, 4, 5, or more) diamine chain extender.

In any aspect or embodiment described herein, the process or method of making the polyurethane elastomer further comprises molding the polyurethane elastomer (e.g., molding an article from the polyurethane elastomer, reaction injection molding, or a combination thereof).

In any aspect or embodiment described herein, molding the polyurethane clastomer comprises preheating a mold to about 80° C. to about 120° C. For example, in any aspect or embodiment described herein, molding the polyurethane elastomer comprises preheating a mold to about 80° C. to about 120° C., about 80° C. to about 110° C., about 80° C. to about 100° C., about 80° C. to about 90° C., about 90° C. to about 120° C., about 90° C. to about 110° C., about 90° C. to about 100° C., about 100° C. to about 120° C., about 100° C. to about 110° C., or about 110° C. to about 120° C.

In any aspect or embodiment described herein, molding the polyurethane elastomer comprises adding the polyurethane elastomer to a mold. In any aspect or embodiment described herein, molding the polyurethane elastomer comprises applying a releasing agent to a mold prior to adding the polyurethane elastomer.

In any aspect or embodiment described herein, molding the polyurethane elastomer comprises curing the polyurethane elastomer in a mold at about 80° C. to about 120° C., for about 16 hours, or a combination thereof. For example, in any aspect or embodiment described herein, molding the polyurethane elastomer comprises curing the polyurethane elastomer in a mold at about 80° C. to about 120° C., about 80° C. to about 110° C., about 80° C. to about 100° C., about 80° C. to about 90° C., about 90° C. to about 120° C., about 90° C. to about 110° C., about 90° C. to about 100° C., about 100° C. to about 120° C., about 100° C. to about 110° C., or about 110° C. to about 120° C. In any aspect or embodiment described herein, molding the polyurethane elastomer comprises curing the polyurethane elastomer in a mold for about 4 hours to about 36 hours, about 4 hours to about 32 hours, about 4 hours to about 28 hours, about 4 hours to about 24 hours, about 4 hours to about 20 hours, about 4 hours to about 18 hours, about 4 hours to about 16 hours, about 4 hours to about 12 hours, about 4 hours to about 8 hours, about 8 hours to about 36 hours, about 8 hours to about 32 hours, about 8 hours to about 28 hours, about 8 hours to about 24 hours, about 8 hours to about 20 hours, about 8 hours to about 18 hours, about 8 hours to about 16 hours, about 8 hours to about 12 hours, about 12 hours to about 36 hours, about 12 hours to about 32 hours, about 12 hours to about 28 hours, about 12 hours to about 24 hours, about 12 hours to about 20 hours, about 12 hours to about 18 hours, about 12 hours to about 16 hours, about 16 hours to about 36 hours, about 16 hours to about 32 hours, about 16 hours to about 28 hours, about 16 hours to about 24 hours, about 16 hours to about 20 hours, about 20 hours to about 36 hours, about 20 hours to about 32 hours, about 20 hours to about 28 hours, about 20 hours to about 24 hours, about 24 hours to about 36 hours, about 24 hours to about 32 hours, about 24 hours to about 28 hours, about 28 hours to about 36 hours, about 28 hours to about 32 hours, about 32 hours to about 36 hours.

In any aspect or embodiment described herein, molding the polyurethane elastomer comprises conditioning a mold with the polyurethane elastomer (e.g., conditioning for a week at about 50% relative humidity at about 23° C.). For example, in aspect or embodiment described herein, molding the polyurethane elastomer comprises conditioning a mold with the polyurethane elastomer for a week at about 40% to about 60% (e.g., about 45% to about 55% or about 50%) relative humidity at about 19° C. to about 27° C. (e.g., about 21° C. to about 25° C. or 23° C.).

In any aspect or embodiment described herein, the polyurethane elastomer comprises a hardness of Shore Hardness A 25 to Shore Hardness of D 75. For example, in any aspect or embodiment described herein, the polyurethane elastomer comprises a hardness of Shore Hardness A 25 to Shore Hardness of D 75, Shore Hardness A 25 to Shore Hardness of D 70, Shore Hardness A 25 to Shore Hardness of D 65, Shore Hardness A 25 to Shore Hardness of D 60, Shore Hardness A 25 to Shore Hardness of D 55, Shore Hardness A 25 to Shore Hardness of D 50, Shore Hardness A 25 to Shore Hardness of A 90, Shore Hardness A 25 to Shore Hardness of A 85, Shore Hardness A 25 to Shore Hardness of A 80, Shore Hardness A 25 to Shore Hardness of A 75, Shore Hardness A 25 to Shore Hardness of A 70, Shore Hardness A 25 to Shore Hardness of A 65, Shore Hardness A 25 to Shore Hardness of A 60, Shore Hardness A 25 to Shore Hardness of A 55, Shore Hardness A 25 to Shore Hardness of A 50, Shore Hardness A 25 to Shore Hardness of A 45, Shore Hardness A 25 to Shore Hardness of A 40, Shore Hardness A 25 to Shore Hardness of A 35, Shore Hardness A 30 to Shore Hardness of D 75, Shore Hardness A 30 to Shore Hardness of D 70, Shore Hardness A 30 to Shore Hardness of D 65, Shore Hardness A 30 to Shore Hardness of D 60, Shore Hardness A 30 to Shore Hardness of D 55, Shore Hardness A 30 to Shore Hardness of D 50, Shore Hardness A 30 to Shore Hardness of A 90, Shore Hardness A 30 to Shore Hardness of A 85, Shore Hardness A 30 to Shore Hardness of A 80, Shore Hardness A 30 to Shore Hardness of A 75, Shore Hardness A 30 to Shore Hardness of A 70, Shore Hardness A 30 to Shore Hardness of A 65, Shore Hardness A 30 to Shore Hardness of A 60, Shore Hardness A 30 to Shore Hardness of A 55, Shore Hardness A 30 to Shore Hardness of A 50, Shore Hardness A 30 to Shore Hardness of A 45, Shore Hardness A 30 to Shore Hardness of A 40, Shore Hardness A 35 to Shore Hardness of D 75, Shore Hardness A 35 to Shore Hardness of D 70, Shore Hardness A 35 to Shore Hardness of D 65, Shore Hardness A 35 to Shore Hardness of D 60, Shore Hardness A 35 to Shore Hardness of D 55, Shore Hardness A 35 to Shore Hardness of D 50, Shore Hardness A 35 to Shore Hardness of A 90, Shore Hardness A 35 to Shore Hardness of A 85, Shore Hardness A 35 to Shore Hardness of A 80, Shore Hardness A 35 to Shore Hardness of A 75, Shore Hardness A 35 to Shore Hardness of A 70, Shore Hardness A 35 to Shore Hardness of A 65, Shore Hardness A 35 to Shore Hardness of A 60, Shore Hardness A 35 to Shore Hardness of A 55, Shore Hardness A 35 to Shore Hardness of A 50, Shore Hardness A 35 to Shore Hardness of A 45, Shore Hardness A 40 to Shore Hardness of D 75, Shore Hardness A 40 to Shore Hardness of D 70, Shore Hardness A 40 to Shore Hardness of D 65, Shore Hardness A 40 to Shore Hardness of D 60, Shore Hardness A 40 to Shore Hardness of D 55, Shore Hardness A 40 to Shore Hardness of D 50, Shore Hardness A 40 to Shore Hardness of A 90, Shore Hardness A 40 to Shore Hardness of A 85, Shore Hardness A 40 to Shore Hardness of A 80, Shore Hardness A 40 to Shore Hardness of A 75, Shore Hardness A 40 to Shore Hardness of A 70, Shore Hardness A 40 to Shore Hardness of A 65, Shore Hardness A 40 to Shore Hardness of A 60, Shore Hardness A 40 to Shore Hardness of A 55, Shore Hardness A 40 to Shore Hardness of A 50, Shore Hardness A 45 to Shore Hardness of D 75, Shore Hardness A 45 to Shore Hardness of D 70, Shore Hardness A 45 to Shore Hardness of D 65, Shore Hardness A 45 to Shore Hardness of D 60, Shore Hardness A 45 to Shore Hardness of D 55, Shore Hardness A 45 to Shore Hardness of D 50, Shore Hardness A 45 to Shore Hardness of A 90, Shore Hardness A 45 to Shore Hardness of A 85, Shore Hardness A 45 to Shore Hardness of A 80, Shore Hardness A 45 to Shore Hardness of A 75, Shore Hardness A 45 to Shore Hardness of A 70, Shore Hardness A 45 to Shore Hardness of A 65, Shore Hardness A 45 to Shore Hardness of A 60, Shore Hardness A 45 to Shore Hardness of A 55, Shore Hardness A 50 to Shore Hardness of D 75, Shore Hardness A 50 to Shore Hardness of D 70, Shore Hardness A 50 to Shore Hardness of D 65, Shore Hardness A 50 to Shore Hardness of D 60, Shore Hardness A 50 to Shore Hardness of D 55, Shore Hardness A 50 to Shore Hardness of D 50, Shore Hardness A 50 to Shore Hardness of A 90, Shore Hardness A 50 to Shore Hardness of A 85, Shore Hardness A 50 to Shore Hardness of A 80, Shore Hardness A 50 to Shore Hardness of A 75, Shore Hardness A 50 to Shore Hardness of A 70, Shore Hardness A 50 to Shore Hardness of A 65, Shore Hardness A 50 to Shore Hardness of A 60, Shore Hardness A 55 to Shore Hardness of D 75, Shore Hardness A 55 to Shore Hardness of D 70, Shore Hardness A 55 to Shore Hardness of D 65, Shore Hardness A 55 to Shore Hardness of D 60, Shore Hardness A 55 to Shore Hardness of D 55, Shore Hardness A 55 to Shore Hardness of D 50, Shore Hardness A 55 to Shore Hardness of A 90, Shore Hardness A 55 to Shore Hardness of A 85, Shore Hardness A 55 to Shore Hardness of A 80, Shore Hardness A 55 to Shore Hardness of A 75, Shore Hardness A 55 to Shore Hardness of A 70, Shore Hardness A 55 to Shore Hardness of A 65, Shore Hardness A 60 to Shore Hardness of D 75, Shore Hardness A 60 to Shore Hardness of D 70, Shore Hardness A 60 to Shore Hardness of D 65, Shore Hardness A 60 to Shore Hardness of D 60, Shore Hardness A 60 to Shore Hardness of D 55, Shore Hardness A 60 to Shore Hardness of D 50, Shore Hardness A 60 to Shore Hardness of A 90, Shore Hardness A 60 to Shore Hardness of A 85, Shore Hardness A 60 to Shore Hardness of A 80, Shore Hardness A 60 to Shore Hardness of A 75, Shore Hardness A 60 to Shore Hardness of A 70, Shore Hardness A 65 to Shore Hardness of D 75, Shore Hardness A 65 to Shore Hardness of D 70, Shore Hardness A 65 to Shore Hardness of D 65, Shore Hardness A 65 to Shore Hardness of D 60, Shore Hardness A 65 to Shore Hardness of D 55, Shore Hardness A 65 to Shore Hardness of D 50, Shore Hardness A 65 to Shore Hardness of A 90, Shore Hardness A 65 to Shore Hardness of A 85, Shore Hardness A 65 to Shore Hardness of A 80, Shore Hardness A 65 to Shore Hardness of A 75, Shore Hardness A 70 to Shore Hardness of D 75, Shore Hardness A 70 to Shore Hardness of D 70, Shore Hardness A 70 to Shore Hardness of D 65, Shore Hardness A 70 to Shore Hardness of D 60, Shore Hardness A 70 to Shore Hardness of D 55, Shore Hardness A 70 to Shore Hardness of D 50, Shore Hardness A 70 to Shore Hardness of A 90, Shore Hardness A 70 to Shore Hardness of A 85, Shore Hardness A 70 to Shore Hardness of A 80, Shore Hardness A 75 to Shore Hardness of D 75, Shore Hardness A 75 to Shore Hardness of D 70, Shore Hardness A 75 to Shore Hardness of D 65, Shore Hardness A 75 to Shore Hardness of D 60, Shore Hardness A 75 to Shore Hardness of D 55, Shore Hardness A 75 to Shore Hardness of D 50, Shore Hardness A 75 to Shore Hardness of A 90, Shore Hardness A 75 to Shore Hardness of A 85, Shore Hardness A 80 to Shore Hardness of D 75, Shore Hardness A 80 to Shore Hardness of D 70, Shore Hardness A 80 to Shore Hardness of D 65, Shore Hardness A 80 to Shore Hardness of D 60, Shore Hardness A 80 to Shore Hardness of D 55, Shore Hardness A 80 to Shore Hardness of D 50, Shore Hardness A 80 to Shore Hardness of A 90, Shore Hardness A 85 to Shore Hardness of D 75, Shore Hardness A 85 to Shore Hardness of D 70, Shore Hardness A 85 to Shore Hardness of D 65, Shore Hardness A 85 to Shore Hardness of D 60, Shore Hardness A 85 to Shore Hardness of D 55, Shore Hardness A 85 to Shore Hardness of D 50, Shore Hardness A 90 to Shore Hardness of D 75, Shore Hardness A 90 to Shore Hardness of D 70, Shore Hardness A 90 to Shore Hardness of D 65, Shore Hardness A 90 to Shore Hardness of D 60, Shore Hardness A 90 to Shore Hardness of D 55, Shore Hardness D 50 to Shore Hardness of D 75, Shore Hardness D 50 to Shore Hardness of D 70, Shore Hardness D 50 to Shore Hardness of D 65, Shore Hardness D 50 to Shore Hardness of D 60, Shore Hardness D 55 to Shore Hardness of D 75, Shore Hardness D 55 to Shore Hardness of D 70, Shore Hardness D 55 to Shore Hardness of D 65 Shore, Shore Hardness D 60 to Shore Hardness of D 75, Shore Hardness D 60 to Shore Hardness of D 70, or Shore Hardness D 65 to Shore Hardness of D 75 Shore.

In any aspect or embodiment described herein, the polyurethane elastomer has a hard segment fraction (e.g., (i) the one or more isocyanate or (ii) the one or more isocyanate and the one or more chain extender) to the polyurethane elastomer that is about 0.20 to about 0.50 (e.g., about 0.25 to about 0.40 or about 0.32). For example, in any aspect or embodiment described herein, the polyurethane elastomer has a fraction of (i) the one or more isocyanate or (ii) the one or more isocyanate and the one or more chain extender to the polyurethane elastomer composition that is about 0.20 to about 0.50 (e.g., about 0.25 to about 0.40 or about 0.32). In any aspect or embodiment described herein, the hard segment fraction of the polyurethane elastomer is about 0.20 to about 0.50, about 0.20 to about 0.45, about 0.20 to about 0.40, about 0.20 to about 0.35, about 0.20 to about 0.30, about 0.20 to about 0.25, about 0.25 to about 0.50, about 0.25 to about 0.45, about 0.25 to about 0.40, about 0.25 to about 0.35, about 0.25 to about 0.30, about 0.30 to about 0.50, about 0.30 to about 0.45, about 0.30 to about 0.40, about 0.30 to about 0.35, about 0.35 to about 0.50, about 0.35 to about 0.45, about 0.35 to about 0.40, about 0.40 to about 0.50, about 0.40 to about 0.45, or about 0.45 to about 0.50.

### Isocyanate

In any aspect or embodiment described herein, the one or more isocyanate

includes or is at least one of monomeric, oligomeric, polymeric, or a mixture thereof. In any aspect or embodiment described herein, the one or more isocyanate includes or is at least one of an aliphatic polyisocyante, mono-cyclic polyisocyanate, aromatic polyisocyanates, aromatic/aliphatic polyisocyanate (e.g., tetramethylxylylene diisocyanate (TMXDI)), or a combination thereof.

In any aspect or embodiment described herein, the one or more isocyanate includes or is at least one of diphenylmethane diisocyanate, isophorone diisocyanate, bimethylene diisocyanate, trimethylene diisocyanate, tetramethylene diisocyanate, pentamethylene diisocyanate, hexamethylene diisocyanate, heptamethylene diisocyanate, toluene diisocyanate, naphthylene diisocyanate, cyclohexylmethane diisocyanate, dicyclohexylmethane diisocyanate, or a mixture thereof.

In any aspect or embodiment described herein, the one or more isocyanate includes or is at least one of 1,3-trimethylene diisocyanate; 2,3-trimethylene diisocyanate; 1,2-trimethylene diisocyanate; 2,2-trimethylene diisocyanate; 1,4-tetramethylene diisocyanate; 1,3-tetramethylene diisocyanate; 1,2-tetramethylene diisocyanate; 2,3-tetramethylene diisocyanate; 1,1-tetramethylene diisocyanate; 2,2-tetramethylene diisocyanate; 1,5-pentamethylene diisocyanate; 1,4-pentamethylene diisocyanate; 1,3-pentamethylene diisocyanate; 1,2-pentamethylene diisocyanate; 2,3-pentamethylene diisocyanate; 2,4-pentamethylene diisocyanate; 3,4-pentamethylene diisocyanate; 3,5-pentamethylene diisocyanate; 1,1-pentamethylene diisocyanate; 2,2-pentamethylene diisocyanate; 3,3-pentamethylene diisocyanate; 1,6-hexamethylene diisocyanate; 1,5-hexamethylene diisocyanate; 1,4-hexamethylene diisocyanate; 1,3-hexamethylene diisocyanate; 1,2-hexamethylene diisocyanate; 2,3-hexamethylene diisocyanate; 2,4-hexamethylene diisocyanate; 2,5-hexamethylene diisocyanate; 3,4-hexamethylene diisocyanate; 3,5-hexamethylene diisocyanate; 4,5-hexamethylene diisocyanate; 1,1-hexamethylene diisocyanate; 2,2-hexamethylene diisocyanate; 3,3-hexamethylene diisocyanate; 1,7-heptamethylene diisocyanate; 1,6-heptamethylene diisocyanate; 1,5-heptamethylene diisocyanate; 1,4-heptamethylene diisocyanate; 1,3-heptamethylene diisocyanate; 1,2-heptamethylene diisocyanate; 2,3-heptamethylene diisocyanate; 2,4-heptamethylene diisocyanate; 2,5-heptamethylene diisocyanate; 2,6-heptamethylene diisocyanate; 3,3-heptamethylene diisocyanate; 3,4-heptamethylene diisocyanate; 1,1-heptamethylene diisocyanate; 2,2-heptamethylene diisocyanate; 3,3-heptamethylene diisocyanate; 4,4-heptamethylene diisocyanate; toluene-2,4-diisocyanate; toluene-2,6-diisocyanate; 1,2-naphthylene diisocyanate; 1,3-naphthylene diisocyanate; 1,4-naphthylene diisocyanate; 1,5-naphthylene diisocyanate; 1,6-naphthylene diisocyanate; 1,7-naphthylene diisocyanate; 1,8-naphthylene diisocyanate; 1,4-cyclohexylmethane diisocyanate; 2,4-cyclohexylmethane diisocyanate; 3,4-cyclohexylmethane diisocyanate; 4,4-cyclohexylmethane diisocyanate; 4,4′-dicyclohexylmethane diisocyanate; 1,4-dicyclohexylmethane diisocyanate; or a mixture thereof.

In any aspect or embodiment described herein, the one or more isocyanate includes or is at least one of 2,2′-diphenylmethane diisocyanate; 2,4′-diphenylmethane diisocyanate; 4,4′-diphenylmethane diisocyanate (MDI); 3,3′-dimethyl-4,4′-biphenylene diisocyanate (TODI); a toluene diisocyanate (TDI); a polymeric MDI; a modified liquid 4,4′-diphenylmethane diisocyanate; hexamethylene-diisocyanate (“HDI”); 4,4′dicyclohexylmethane diisocyanate (“H₁₂ MDI”); isophorone diisocyanate (“IPDI”); para-phenylene diisocyanate (“PPDI”); meta-phenylene diisocyanate (“MPDI”); tetramethylene diisocyanate; dodecane diisocyanate; octamethylene diisocyanate; decamethylene diisocyanate; cyclobutane-1,3-diisocyanate; 1,2-cyclohexane diisocyanate; 1,3-cyclohexane diisocyanate; 1,4-cyclohexane diisocyanate; 2,4-methylcyclohexane diisocyanate; 2,6-methylcyclohexane diisocyanate; 4,4′-dicyclohexyldiisocyanate; 2,4′-dicyclohexyldiisocyanate; 1,3,5-cyclohexane triisocyanate; a isocyanate-methylcyclohexane isocyanate; a isocyanatocthylcyclohexane isocyanate; a bis(isocyanatomethyl)-cyclohexane diisocyanate; 4,4′-bis(isocyanatomethyl) dicyclohexane; 2,4′-bis(isocyanatomethyl) dicyclohexane; 2,4-hexahydrotoluenediisocyanate; 2,6-hexahydrotoluenediisocyanate; 1,2-phenylene diisocyanate; 1,3-phenylene diisocyanate; 1,4-phenylene diisocyanate; triphenyl methane-4,4′,4″-triisocyanate; naphthylene-1,5-diisocyanate; 2,4′-biphenyl diisocyanate; 4,4′-biphenyl diisocyanate; 2,2-biphenyl diisocyanate; a polyphenyl polymethylene polyisocyanate (“PMDI”); meta-tetramethylxylene diisocyanate (“m-TMXDI”); para-tetramethylxylene diisocyanate (“p-TMXDI”); or a mixture thereof.

In any aspect or embodiment described herein, the one or more isocyanate includes or is at least one of 4,4′-diphenylmethane diisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof.

In any aspect or embodiment described herein, the one or more isocyanate includes or is 4,4′-diisocyanate dicyclohexylmethane.

### Additional Polyol

In any aspect or embodiment described herein, the one or more additional polyol includes or is a low-molecular-weight polyol having a number average molecular weight of 400 or less. In any aspect or embodiment described herein, the one or more additional polyol has three or more hydroxyl groups.

In any aspect or embodiment described herein, the one or more additional polyol includes or is at least one of: one or more (e.g., 1, 2, 3, 4, 5, or more) trihydric alcohol (e.g., low-molecular-weight triol); one or more (e.g., 1, 2, 3, 4, 5, or more) tetrahydric alcohol (e.g., low-molecular-weight tetrol); one or more (e.g., 1, 2, 3, 4, 5, or more) pentahydric alcohol (e.g., low-molecular-weight pentol); one or more (e.g., 1, 2, 3, 4, 5, or more) hexahydric alcohol (e.g., a low-molecular-weight hexol); one or more (e.g., 1, 2, 3, 4, 5, or more) heptahydric alcohol (e.g., low-molecular-weight heptol); one or more (e.g., 1, 2, 3, 4, 5, or more) octahydric alcohol (e.g., low-molecular-weight octahydric alcohol); one or more (e.g., 1, 2, 3, 4, 5, or more) polyalkylene oxide having three or more hydroxyl groups (e.g., low-molecular weight polyalkylene oxide having three or more hydroxyl groups); or a combination thereof.

In any aspect or embodiment described herein, the one or more additional polyol includes or is at least one of glycerin; 2-methyl-2-hydroxymethyl-1,3-propanediol; 2,4-dihydroxy-3-hydroxymethylpentane; 1,2,6-hexanetriol; trimethylolpropane; 2,2-bis(hydroxymethyl)-3-butanol; tetramethylolmethane (pentaerythritol); diglycerol; xylitol; sorbitol; mannitol; iditol; dulcitol; altritol; inositol; dipentaerythritol; perseitol; sucrose; polyethylenepolyol, polypropylenepolyol, polyethylenepolypropylenepolyol (such as a random copolymer or a block copolymer); or a combination thereof.

In any aspect or embodiment described herein, the one or more additional polyol includes or is at least one of N-butanol; ethylene glycol; 1,2-propanediol; 1,3-butanediol; 1,4-butanediol; 2,3-butanediol; 1,5-pentanediol; 1,6-hexanediol; neopentyl glycol; 1,4-dihydroxycyclohexane; 1,4-dimethylolcyclohexane; 1,8-octanediol; 1,10-decanediol; 1,12-dodecanediol; 1,4-cyclohexanediol; 1,4-cyclohexanedimethanol; N-substituted ethanolamine; glycerol; trimethylolpropane; trimethylolethane; pentaerythritol; or a combination thereof.

### Chain Extender

In any aspect or embodiment described herein, the one or more chain extender includes or is a diol chain extender that includes or is an aliphatic diol or an aromatic diol.

In any aspect or embodiment described herein, the one or more diol chain extender includes or is at least one of an alkylene oxide or glycol, ethylene glycol, propanediol, butanediol, pentadiol, hexanediol, heptadiol, dihydroxybenzene, di(hydroxyethyl)-hydroxyquinone, di(hydroxymethyl)-hydroxyquinone, di-(hydroxyethyl)-bisphenol A, or a mixture thereof.

In any aspect or embodiment described herein, the one or more diamine chain extender includes or is at least one of diaminodiphenylmethane, dichloro-diaminodiphenylmethane, diaminobenzene, dimethoxy-diamino biphenyl, dimethyl-diamino biphenyl, diamino biphenyl, dichloro-diamino biphenyl, or a mixture thereof.

In any aspect or embodiment described herein, the one or more chain extender includes or is one or more (e.g., 1, 2, 3, 4, 5, or more) diol chain extender that includes or is at least one of 1,3-propanediol; 1,2-propanediol; 1,1-propanediol; 2,2-propanediol; 1,4-butanediol; 1,3-butanediol; 1,2-butanediol; 2,3-butanediol; 1,1-butanediol; 2,2-butanediol; 1,5-pentadiol; 1,4-pentadiol; 1,3-pentadiol; 1,2-pentadiol; 2,3-pentadiol; 2,4-pentadiol; 3,4-pentadiol; 3,5-hexanediol; 1,1-pentadiol; 2,2-pentadiol; 3,3-pentadiol; 1,6-hexanediol; 1,5-hexanediol; 1,4-hexanediol; 1,3-hexanediol; 1,2-hexanediol; 2,3-hexanediol; 2,4-hexanediol; 2,5-hexanediol; 3,4-hexanediol; 3,5-hexanediol; 4,5-hexanediol; 1,1-hexanediol; 2,2-hexanediol; 3,3-hexanediol; 1,7-heptadiol; 1,6-heptadiol; 1,5-heptadiol; 1,4-heptadiol; 1,3-heptadiol; 1,2-heptadiol; 2,3-heptadiol; 2,4-heptadiol; 2,5-heptadiol; 2, 6-heptadiol; 3,3-heptadiol; 3,4-heptadiol; 1,1-heptadiol; 2,2-heptadiol; 3,3-heptadiol; 4,4-heptadiol; 1,2-dihydroxybenzene; 1,3-dihydroxybenzene; 1,4-dihydroxybenzene; 1,4-di-(betahydroxyethyl)-hydroxyquinone; 2,5-di-(hydroxyethyl)-hydroxyquinone; 2,3-di-(hydroxyethyl)-hydroxyquinone; 3,5-di-(hydroxyethyl)-hydroxyquinone; 2,5-di-(hydroxyethyl)-hydroxyquinone; 2,3-di-(hydroxymethyl)-hydroxyquinone; 3,5-di-(hydroxymethyl)-hydroxyquinone; 1,4-di-(betahydroxyethyl)-bisphenol A; 1,3-di-(betahydroxyethyl)-bisphenol A; 1,2-di-(betahydroxyethyl)-bisphenol A; 1,5-di-(betahydroxyethyl)-bisphenol A; 2,3-di-(betahydroxyethyl)-bisphenol A; 2,4-di-(betahydroxyethyl)-bisphenol A; 2,5-di-(betahydroxyethyl)-bisphenol A; 2,6-di-(betahydroxyethyl)-bisphenol A; 3,4-di-(betahydroxyethyl)-bisphenol A; 3,5-di-(betahydroxyethyl)-bisphenol A; or a mixture thereof.

In any aspect or embodiment described herein, the one or more chain extender includes or is one or more (e.g., 1, 2, 3, 4, 5, or more) diamine chain extender that includes or is at least one of 2,2′-diaminodiphenylmethane; 2,3′-diaminodiphenylmethane; 2,4′-diaminodiphenylmethane; 2,5′-diaminodiphenylmethane; 2,6′-diaminodiphenylmethane; 3,4′-diaminodiphenylmethane; 3,5′-diaminodiphenylmethane; 3,6′-diaminodiphenylmethane; 4,4′-diaminodiphenylmethane; 4,5′-diaminodiphenylmethane; 4,6′-diaminodiphenylmethane; 5,6′-diaminodiphenylmethane; 2,2′-dichloro-3,3′-diaminodiphenylmethane; 2,2′-dichloro-4,4′-diaminodiphenylmethane; 5,5′-dichloro-3,3′-diaminodiphenylmethane; 2,2′-dichloro-6,6′-diaminodiphenylmethane; 2,2′-dichloro-3,4′-diaminodiphenylmethane; 2,2′-dichloro-3,5′-diaminodiphenylmethane; 2,2′-dichloro-3,6′-diaminodiphenylmethane; 2,2′-dichloro-4,5′-diaminodiphenylmethane; 2,2′-dichloro-4,6′-diaminodiphenylmethane; 2,2′-dichloro-5,6′-diaminodiphenylmethane; 3,3′-dichloro-5,5′-diaminodiphenylmethane; 3,3′-dichloro-6,6′-diaminodiphenylmethane; 3,3′-dichloro-2,5′-diaminodiphenylmethane; 3,3′-dichloro-4,5′-diaminodiphenylmethane; 3,3′-dichloro-6,5′-diaminodiphenylmethane; 3,3′-dichloro-4,2′-diaminodiphenylmethane; 3,3′-dichloro-4,6′-diaminodiphenylmethane; 4,4′-dichloro-2,2′-diaminodiphenylmethane; 4,4′-dichloro-3,3′-diaminodiphenylmethane; 4,4′-dichloro-5,5′-diaminodiphenylmethane; 4,4′-dichloro-6,6′-diaminodiphenylmethane; 4,4′-dichloro-2,3′-diaminodiphenylmethane; 4,4′-dichloro-2,5′-diaminodiphenylmethane; 4,4′-dichloro-2,6′-diaminodiphenylmethane; 4,4′-dichloro-3,5′-diaminodiphenylmethane; 4,4′-dichloro-3,6′-diaminodiphenylmethane; 4,4′-dichloro-5,6′-diaminodiphenylmethane; 5,5′-dichloro-2,2′-diaminodiphenylmethane; 5,5′-dichloro-3,3′-diaminodiphenylmethane; 5,5′-dichloro-4,4′-diaminodiphenylmethane; 5,5′-dichloro-6,6′-diaminodiphenylmethane; 5,5′-dichloro-2,3′-diaminodiphenylmethane; 5,5′-dichloro-2,4′-diaminodiphenylmethane; 5,5′-dichloro-2,6′-diaminodiphenylmethane; 5,5′-dichloro-3,4′-diaminodiphenylmethane; 5,5′-dichloro-3,6′-diaminodiphenylmethane; 5,5′-dichloro-4,6′-diaminodiphenylmethane; 6,6′-dichloro-2,2′-diaminodiphenylmethane; 6,6′-dichloro-3,3′-diaminodiphenylmethane; 6,6′-dichloro-4,4′-diaminodiphenylmethane; 6,6′-dichloro-5,5′-diaminodiphenylmethane; 6,6′-dichloro-2,3′-diaminodiphenylmethane; 6,6′-dichloro-2,4′-diaminodiphenylmethane; 6,6′-dichloro-2,5′-diaminodiphenylmethane; 6,6′-dichloro-3,4′-diaminodiphenylmethane; 6,6′-dichloro-3,5′-diaminodiphenylmethane; 6,6′-dichloro-4,5′-diaminodiphenylmethane; 1,4-diaminobenzene; 1,2-diaminobenzene; 1,3-diaminobenzene; 2,2′-dimethoxy-3,3′-diamino biphenyl; 2,2′-dimethoxy-4,4′-diamino biphenyl; 5,5′-dimethoxy-3,3′-diamino biphenyl; 2,2′-dimethoxy-6,6′-diamino biphenyl; 2,2′-dimethoxy-3,4′-diamino biphenyl; 2,2′-dimethoxy-3,5′-diamino biphenyl; 2,2′-dimethoxy-3,6′-diamino biphenyl; 2,2′-dimethoxy-4,5′-diamino biphenyl; 2,2′-dimethoxy-4,6′-diamino biphenyl; 2,2′-dimethoxy-5,6′-diamino biphenyl; 3,3′-dimethoxy-2,2′-diamino biphenyl; 3,3′-dimethoxy-4,4-diamino biphenyl; 3,3′-dimethoxy-5,5′-diamino biphenyl; 3,3′-dimethoxy-6,6′-diamino biphenyl; 3,3′-dimethoxy-2,5′-diamino biphenyl; 3,3′-dimethoxy-4,5′-diamino biphenyl; 3,3′-dimethoxy-6,5′-diamino biphenyl; 3,3′-dimethoxy-4,2′-diamino biphenyl; 3,3′-dimethoxy-4,6′-diamino biphenyl; 4,4′-dimethoxy-2,2′-diamino biphenyl; 4,4′-dimethoxy-3,3′-diamino biphenyl; 4,4′-dimethoxy-5,5′-diamino biphenyl; 4,4′-diamino biphenyl; 4,4′-dimethoxy-2,6′-diamino biphenyl; 4,4′-dimethoxy-3,5′-diamino biphenyl; 4,4′-dimethoxy-3,6′-diamino biphenyl; 4,4′-dimethoxy-5,6′-diamino biphenyl; 5,5′-dimethoxy-2,2′-diamino biphenyl; 5,5′-dimethoxy-3,3′-diamino biphenyl; 5,5′-dimethoxy-4,4′-diamino biphenyl; 5,5′-dimethoxy-6,6′-diamino biphenyl; 5,5′-dimethoxy-2,3′-diamino biphenyl; 5,5′-dimethoxy-2,4′-diamino biphenyl; 5,5′-dimethoxy-2,6′-diamino biphenyl; 5,5′-dimethoxy-3,4′-diamino biphenyl; 5,5′-dimethoxy-3,6′-diamino biphenyl; 5,5′-dimethoxy-4,6′-diamino biphenyl; 6,6′-dimethoxy-2,2′-diamino biphenyl; 6,6′-dimethoxy-3,3′-diamino biphenyl; 6,6′-dimethoxy-4,4′-diamino biphenyl; 6,6′-dimethoxy-5,5′-diamino biphenyl; 6,6′-dimethoxy-2,3′-diamino biphenyl; 6,6′-dimethoxy-2,4′-diamino biphenyl; 6,6′-dimethoxy-2,5′-diamino biphenyl; 6,6′-dimethoxy-3,4′-diamino biphenyl; 6,6′-dimethoxy-3,5′-diamino biphenyl; 6,6′-dimethoxy-4,5′-diamino biphenyl; 2,2′-dimethyl-3,3′-diamino biphenyl; 2,2′-dimethyl-4,4′-diamino biphenyl; 5,5′-dimethyl-3,3′-diamino biphenyl; 2,2′-dimethyl-6,6′-diamino biphenyl; 2,2′-dimethyl-3,4′-diamino biphenyl; 2,2′-dimethyl-3,5′-diamino biphenyl; 2,2′-dimethyl-3,6′-diamino biphenyl; 2,2′-dimethyl-4,5′-diamino biphenyl; 2,2′-dimethyl-4,6′-diamino biphenyl; 2,2′-dimethyl-5,6′-diamino biphenyl; 3,3′-dimethyl-2,2′-diamino biphenyl; 3,3′-dimethyl-4,4-diamino biphenyl; 3,3′-dimethyl-5,5′-diamino biphenyl; 3,3′-dimethyl-6,6′-diamino biphenyl; 3,3′-dimethyl-2,5′-diamino biphenyl; 3,3′-dimethyl-4,5′-diamino biphenyl; 3,3′-dimethyl-6,5′-diamino biphenyl; 3,3′-dimethyl-4,2′-diamino biphenyl; 3,3′-dimethyl-4,6′-diamino biphenyl; 4,4′-dimethyl-2,2′-diamino biphenyl; 4,4′-dimethyl-3,3′-diamino biphenyl; 4,4′-dimethyl-5,5′-diamino biphenyl; 4,4′-dimethyl-6,6′-diamino biphenyl; 4,4′-dimethyl-2,3′-diamino biphenyl; 4,4′-dimethyl-2,5′-diamino biphenyl; 4,4′-dimethyl-2,6′-diamino biphenyl; 4,4′-dimethyl-3,5′-diamino biphenyl; 4,4′-dimethyl-3,6′-diamino biphenyl; 4,4′-dimethyl-5,6′-diamino biphenyl; 5,5′-dimethyl-2,2′-diamino biphenyl; 5,5′-dimethyl-3,3′-diamino biphenyl; 5,5′-dimethyl-4,4′-diamino biphenyl; 5,5′-dimethyl-6,6′-diamino biphenyl; 5,5′-dimethyl-2,3′-diamino biphenyl; 5,5′-dimethyl-2,4′-diamino biphenyl; 5,5′-dimethyl-2,6′-diamino biphenyl; 5,5′-dimethyl-3,4′-diamino biphenyl; 5,5′-dimethyl-3,6′-diamino biphenyl; 5,5′-dimethyl-4,6′-diamino biphenyl; 6,6′-dimethyl-2,2′-diamino biphenyl; 6,6′-dimethyl-3,3′-diamino biphenyl; 6,6′-dimethyl-4,4′-diamino biphenyl; 6,6′-dimethyl-5,5′-diamino biphenyl; 6,6′-dimethyl-2,3′-diamino biphenyl; 6,6′-dimethyl-2,4′-diamino biphenyl; 6,6′-dimethyl-2,5′-diamino biphenyl; 6,6′-dimethyl-3,4′-diamino biphenyl; 6,6′-dimethyl-3,5′-diamino biphenyl; 6,6′-dimethyl-4,5′-diamino biphenyl; 2,2′-diamino biphenyl; 2,3′-diamino biphenyl; 2,4′-diamino biphenyl; 2,5′-diamino biphenyl; 2,6′-diamino biphenyl; 3,4′-diamino biphenyl; 3,5′-diamino biphenyl; 3,6′-diamino biphenyl; 4,4′-diamino biphenyl; 4,5′-diamino biphenyl; 4,6′-diamino biphenyl; 5,6′-diamino biphenyl; 2,2′-dichloro-3,3′-diamino biphenyl; 2,2′-dichloro-4,4′-diamino biphenyl; 5,5′-dichloro-3,3′-diamino biphenyl; 2,2′-dichloro-6,6′-diamino biphenyl; 2,2′-dichloro-3,4′-diamino biphenyl; 2,2′-dichloro-3,5′-diamino biphenyl; 2,2′-dichloro-3,6′-diamino biphenyl; 2,2′-dichloro-4,5′-diamino biphenyl; 2,2′-dichloro-4,6′-diamino biphenyl; 2,2′-dichloro-5,6′-diamino biphenyl; 3,3′-dichloro-2,2′-diamino biphenyl; 3,3′-dichloro-4,4′-diamino biphenyl; 3,3′-dichloro-5,5′-diamino biphenyl; 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl; 4,4′-dichloro-2,2′-diamino biphenyl; 4,4′-dichloro-3,3′-diamino biphenyl; 4,4′-dichloro-5,5′-diamino biphenyl; 4,4′-dichloro-6,6′-diamino biphenyl; 4,4′-dichloro-2,3′-diamino biphenyl; 4,4′-dichloro-2,5′-diamino biphenyl; 4,4′-dichloro-2,6′-diamino biphenyl; 4,4′-dichloro-3,5′-diamino biphenyl; 4,4′-dichloro-3,6′-diamino biphenyl; 4,4′-dichloro-5,6′-diamino biphenyl; 5,5′-dichloro-2,2′-diamino biphenyl; 5,5′-dichloro-3,3′-diamino biphenyl; 5,5′-dichloro-4,4′-diamino biphenyl; 5,5′-dichloro-6,6′-diamino biphenyl; 5,5′-dichloro-2,3′-diamino biphenyl; 5,5′-dichloro-2,4′-diamino biphenyl; 5,5′-dichloro-2,6′-diamino biphenyl; 5,5′-dichloro-3,4′-diamino biphenyl; 5,5′-dichloro-3,6′-diamino biphenyl; 5,5′-dichloro-4,6′-diamino biphenyl; 6,6′-dichloro-2,2′-diamino biphenyl; 6,6′-dichloro-3,3′-diamino biphenyl; 6,6′-dichloro-4,4′-diamino biphenyl; 6,6′-dichloro-5,5′-diamino biphenyl; 6,6′-dichloro-2,3′-diamino biphenyl; 6,6′-dichloro-2,4′-diamino biphenyl; 6,6′-dichloro-2,5′-diamino biphenyl; 6,6′-dichloro-3,4′-diamino biphenyl; 6,6′-dichloro-3,5′-diamino biphenyl; 6,6′-dichloro-4,5′-diamino biphenyl; or a mixture thereof.

In any aspect or embodiment described herein, the one or more chain extender includes or is at least one of diethylene triamine (DETA), ethylene diamine (EDA), meta-xylylenediamine (MXDA), aminoethyl ethanolamine (AEEA), 2-methyl pentane diamine, propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, hydrazine, substituted hydrazine, hydrazine reaction products, or a combination thereof.

In any aspect or embodiment described herein, the one or more chain extender includes or is 1,4-butanediol.

### Methods of Using the Prepolymer Composition, Polyurethane Dispersion, or Waterborne Polyurethane of the Present Disclosure

An further aspect of the present disclosure relates to an article comprising, or produced from, of one or more (e.g., 1, 2, 3, 4,5 or more) the polyurethane material, polymer, or polyurethane elastomer of the present disclosure, or one or more (e.g., 1, 2, 3, 4,5 or more) polyurethane material, polymer, or polyurethane elastomer produced by the method of the present disclosure.

Another aspect of the present disclosure relates to an article comprising the polyurethane material, polymer, or polyurethane elastomer of the present disclosure.

### EXAMPLES

The details of the examples are contemplated as further embodiments of the described methods and compositions. Therefore, the details as set forth herein are hereby incorporated into the detailed description as alternative embodiments. It was surprising and unexpected discovered that the caprolactone polyols of the present disclosure provides polyurethane elastomers improved stain resistance, as compared to standard, commercially available polyols.

Hydroxyl Value. Hydroxyl value (OHV) was determined via American Society for Testing and Materials (ASTM) E222-23 (2023)—Standard Test Methods for Hydroxyl Groups Using Acetic Anhydride Acetylation. Briefly, the material examined was reacted with acetic anhydride and then acidified with water to provide an acidic mixture. The acidic mixture was then back titrated with KOH to provide the hydroxyl value in mgKOH/g.

Acid Number. Acid number was determined by dissolving the test sample in acetone or industrial methylated spirits (IMS), and then titrated against KOH to provide the acid number in mgKOH/g.

NCO Content. NCO percent (NCO %) was determined via an adapted version of Test Method B of the American Society for Testing and Materials (ASTM) D5155-01—Standard Test Methods for Polyurethane Raw Materials Determination of the Isocyanate Content of Aromatic Isocyanates. Briefly, 3-3.5 g of prepolymer sample was weighed into a sample pot, 40 mL anhydrous toluene was added, and mixed for 5 minutes until dissolved. Dibutylamine (20% in anhydrous toluene; 10 mL) was added and the mixture stirred for 15 minutes. 40ml isopropyl (40 mL) was added and the mixture back titrated with the 1M HCl.

### Example 1. Polyol Synthesis

The 2000 MW polyol (Polyol Example 1) was synthesized via a one pot method, ring opening polymerization. Caprolactone monomers (84.8 wt %; Ingevity UK Ltd, Warrington, United Kingdom) were mixed with 15.2 wt % pentaspiroglycol (PSG; Perstorp Holding AB, Malmö, Sweden) as the initiator and reacted to give a resulting polymer of 2000 MW with a hydroxyl value of 54-58 mgKOH/g. The 2000 MW polyol (Polyol Example 1) was heated and held under vacuum at temperatures <100° C. to remove excess water.

Next, a stannous octanoate catalyst (DABCO® T-9 Catalyst; EVONIK CORPORATION, Parsippany, New Jersey) was added at 160° C. and then the reaction mixture was heated to 180° C. and incubated until the residual caprolactone monomer was <0.5%, as determined by gas chromatography. Monomeric carbodiimide (BASF, Ludwigshafen, Germany), an acid scavenger, was added to the resulting polymers to give a resulting acid number of <0.05 mgKOH/g.

Caprolactone Siloxane A0 was synthesized via a one pot method, ring opening polymerization. Caprolactone monomers (800 g; Ingevity UK Ltd, Warrington, United Kingdom) were mixed with SILMER® OHT A0 (200 g; Siltech Corporation, Toronto, Canada), STABAXOL® I (1.7 g; Rhein Chemie, Mannheim, Germany), IRGANOX® 1010 (10 g; BASF, Ludwigshafen am Rhein, Germany), LOWINOX™ 44B25 (5 g; Safi Alcam, Puteaux, France), and IRGAFOS® 126 (10 g; _BASF, Ludwigshafen am Rhein, Germany), and sparged at 90° C. at 20 mbar for 1.5 hours. The mixture (water content of 0.010%) was then heated to 150° C. at 200 mbar for 2 hours with TYZOR® TnBT (40 ppm; Dorf Ketal, Houston, Texas) added at 140° C. The vacuum reduced gradually during the reaction and slight discoloration observed after 4.5 hours. After 10 hours, the polyol with an acid valued of 0.04 mgKOH/g was treated with STABAXOL® I (Rhein Chemie, Mannheim, Germany) and the final polyol examined. The Caprolactone Siloxane A0 had a hydroxyl value of 52.98 mgKOH/g, an acid value of 0.01 mgKOH/g, and a molecular weight of 2117 g/mol (MW).

Caprolactone Siloxane Di-10 (linear, 2 reactive alcohol functional groups, 2000 MW) was also synthesized via a one pot method, ring opening polymerization. The process was performed as described for Caprolactone Siloxane A0, but with the use of SILMER® OHT Di-10 (200 g; Siltech Corporation, Toronto, Canada) instead of SILMER® OHT A0 (200 g; Siltech Corporation, Toronto, Canada).

### Example 2. Polyurethane Elastomer Synthesis

The formulations and processing parameters of the inventive and comparative polyurethane elastomers are shown in Table 1, wherein the target formulation has a hard segment (i.e., isocyanate and chain extender) fraction of 0.32 to produce an 80 Shore A polyurethane elastomers and a prepolymer with an NCO content of 6.21%.

TABLE 1
Polyurethane Elastomer Formulations

| | | Target | Polyol | 4,4′-diisocyanate | 1,4- |
|---|---|---|---|---|---|
| | | Hard | (parts | dicyclohexylmethane | butanediol |
| | Polyol | Segment | by | (MDI) (parts by | (parts by |
| Sample | System | Fraction | weight) | weight) | weight) |
| Polyurethane | Polyol Example | 0.32 | 100 | 38 | 8.8 |
| Elastomer 1 | 1 (Caprolactone | | | | |
| | PSG 2000 MW) | | | | |
| Comparative | CAPA ® 2201A | 0.32 | 100 | 38 | 8.8 |
| Polyurethane | (2000 MW | | | | |
| Elastomer 1 | polycaprolactone | | | | |
| | polyol diol | | | | |
| | initiated with | | | | |
| | neopentyl | | | | |
| | glycol; Ingevity | | | | |
| | UK Ltd, | | | | |
| | Warrington, | | | | |
| | United | | | | |
| | Kingdom) | | | | |
| Comparative | CAPA ® 2201 | 0.32 | 100 | 38 | 8.8 |
| Polyurethane | (2000 MW | | | | |
| Elastomer 2 | polycaprolactone | | | | |
| | polyol diol | | | | |
| | initiated with | | | | |
| | neopentyl | | | | |
| | glycol; Ingevity | | | | |
| | UK Ltd, | | | | |
| | Warrington, | | | | |
| | United | | | | |
| | Kingdom)) | | | | |
| Comparative | 1,4-butanediol | 0.32 | 100 | 38 | 8.8 |
| Polyurethane | (BDO) adipate | | | | |
| Elastomer 3 | | | | | |
| Comparative | 1,6-hexanediol | 0.32 | 100 | 38 | 8.8 |
| Polyurethane | (HDO) adipate | | | | |
| Elastomer 4 | | | | | |
| Comparative | Caprolactone | 0.32 | 100 | 38 | 8.8 |
| Polyurethane | Siloxane A0 | | | | |
| Elastomer 5 | | | | | |
| Comparative | Caprolactone | 0.32 | 100 | 38 | 8.8 |
| Polyurethane | Siloxane Di-10 | | | | |
| Elastomer 6 | | | | | |
| Comparative | CAPA ® 7203 | 0.32 | 100 | 38 | 8.8 |
| Polyurethane | (2000 MW | | | | |
| Elastomer 7 | polycaprolactone | | | | |
| | polyol diol | | | | |
| | initiated with | | | | |
| | polycarbonate | | | | |
| | (aliphatic type); | | | | |
| | Ingevity UK | | | | |
| | Ltd, Warrington, | | | | |
| | United | | | | |
| | Kingdom) | | | | |

Using hydroxy value (OHV) of polyol and NCO content (NCO %) of the isocyanate, 4,4′-diisocyanate dicyclohexylmethane (MDI), polyurethane elastomer formulation with a hard segment fraction of 0.32 were prepared to produce 80 Shore A polyurethane elastomers. A hard segment fraction of 0.32 was used for illustrative purposes and thus, other hard segment reactions may be used.

The MDI was melted in a reactor at 60° C. under nitrogen blanket. The polyol was added, and the mixture stirred at 80° C. for 1.5 hours (prepolymer). The resultant prepolymer was degassed under vacuum. The NCO content (NCO %) of the prepolymer was examined to confirm it was at the desired level (6.21%), thereby confirming the end of reaction.

The prepolymer was mixed with an amount of chain extender to reach a 103 isocyanate index, and the mixed at 2,000 rotations per minute for 30 seconds. The resultant polyurethane elastomers were cast into moulds preheated to 80° C. and treated with release agent. Once the moulds were visibly set, they were transferred to a curing oven at 80° C. to cure for 16 hours. The cured samples were then transferred to a conditioning over (50% relative humidity at 23° C.) for a week.

The samples were then examined.

### Example 3. Evaluation of Polyurethane Elastomers

Example 3 examines the performance advantages of polyurethan elastomers associated with the use of Polyol Example 1.

Table 2 shows the stain resistance results for Polyurethane Elastomer 1 (Polyol Example 1, caprolactone PSG 2000 MW), Comparative Polyurethane Elastomer 1 (CAPA® 2201A, 2000 MW polycaprolactone polyol diol initiated with neopentyl glycol), Comparative Polyurethane Elastomer 2 (CAPA® 2201, 2000 MW polycaprolactone polyol diol initiated with neopentyl glycol), Comparative Polyurethane Elastomer 3 (1,4-butanediol (BDO) adipate, 2000 MW),Comparative Polyurethane Elastomer 4 (1,6-butanediol (HDO) adipate, 2000 MW), Comparative Polyurethane Elastomer 5 (Caprolactone Siloxane A0), Comparative Polyurethane Elastomer 6 (Caprolactone Siloxane Di-10), and Comparative Polyurethane Elastomer 7 (CAPA® 7203, 2000 MW polycaprolactone polyol diol initiated with polycarbonate (aliphatic type)).

The polyurethane elastomers were examined using the American Society for Testing and Materials (ASTM) C1378-20—Standard Test Method for Determination of Resistance to Staining). Briefly, two coats, each a 10 wet mill deposition, were applied to Lanetta gloss cards. Each coat was dried for 5 minutes at 60° C., followed by 3 minutes at 150° C. Each test chemical spot was applied for a duration of 1 hour at ambient temperature. Coatings were rated for “BLUSHING” and “SOFTENING” immediately upon removal of test chemicals and after 1 hour room temperature recovery time. The rating system is from 0 to 10 with 0 =destruction and 10 =no affect.

The polyurethane elastomers were examined using the American Society for Testing and Materials (ASTM) D6578/D6578M—13 (2018)—Standard Practice for Determination of Graffiti Resistance.

The polyurethane elastomers were examined for color fastness using the International Organization for Standardization (ISO) standard ISO 105-X12 (2016)—Textiles—Test for colour fastness—Part X12: Colour fastness to rubbing. Briefly, denatured Ethanol Double Rubs was applied with an ethanol soaked denim to stain the moulded polyurethane elastomer being examined.

The polyurethane elastomers were examined for color fastness using the International Organization for Standardization (ISO) standard ISO 105-D02 (2016)—Textiles—Test for colour fastness—Part D02: Colour fastness to rubbing: Organic solvents.

TABLE 2
Staining results for Polyurethane Elastomer
1 and Comparative Polyurethane Elastomers 1-7

| | Results | |
|---|---|---|
| Sample | (number of rotations to stain) | Comments |
| Capa PSG 2000 | 10,000 | No staining after 10,000 rotations. |
| Elastomer | 10,000 | The 7,000 rotations sample had an |
| | 7,000 | imperfection in the sheet. |
| | 10,000/53,000 | The final sample was run until 53,000 |
| | | rotations, which finally abraded the |
| | | sheen and had very minor staining. |
| Capa 2201A | 756 | Stained |
| Elastomer | 704 | |
| | 799 | |
| Capa 2201 | 626 | Stained |
| Elastomer | 683 | |
| | 711 | |
| BDO Adipate | 67 | Stained |
| Elastomer | 64 | |
| HDO Adipate | 70 | Stained |
| Elastomer | 78 | |
| Capa siloxane A0 | 10,000 | General observations show early |
| Elastomer | 8160 | abrasion of surface however no staining |
| | | observed after 10,000 rotations. |
| | | The second sample had an imperfection |
| | | in the sheet which caused some minor |
| | | staining. |
| Capa siloxane Di-10 | 10,000 | No staining |
| Elastomer | 10,000 | |
| Capa 7203 | 900 | Stained |
| Elastomer | 896 | |

Polyurethane elastomers were prepared in Example 2 for the purpose of direct comparison of inherent properties obtained from each of the chosen polyols—namely, Polyurethane Elastomer 1 (Polyol Example 1, caprolactone PSG 2000 MW), Comparative Polyurethane Elastomer 1 (CAPA® 2201A, 2000 MW polycaprolactone polyol diol initiated with neopentyl glycol), Comparative Polyurethane Elastomer 2 (CAPA® 2201, 2000 MW polycaprolactone polyol diol initiated with neopentyl glycol), Comparative Polyurethane Elastomer 3 (1,4-butanediol (BDO) adipate, 2000 MW),Comparative Polyurethane Elastomer 4 (1,6-butanediol (HDO) adipate, 2000 MW), Comparative Polyurethane Elastomer 5 (Caprolactone Siloxane A0), Comparative Polyurethane Elastomer 6 (Caprolactone Siloxane Di-10), and Comparative Polyurethane Elastomer 7 (CAPA® 7203, 2000 MW polycaprolactone polyol diol initiated with polycarbonate (aliphatic type)). The evaluation demonstrated that Polyol Example 1 (2000 MW) enhanced specific properties as compared to the Comparative Polyurethane Elastomer 1 (CAPA® 2201A, 2000 MW polycaprolactone polyol diol initiated with neopentyl glycol), Comparative Polyurethane Elastomer 2 (CAPA® 2201, 2000 MW polycaprolactone polyol diol initiated with neopentyl glycol), Comparative Polyurethane Elastomer 3 (1,4-butanediol (BDO) adipate, 2000 MW),Comparative Polyurethane Elastomer 4 (1,6-butanediol (HDO) adipate, 2000 MW), Comparative Polyurethane Elastomer 5 (Caprolactone Siloxane A0), Comparative Polyurethane Elastomer 6 (Caprolactone Siloxane Di-10), and Comparative Polyurethane Elastomer 7 (CAPA® 7203, 2000 MW polycaprolactone polyol diol initiated with polycarbonate (aliphatic type)). The enhancements include an improvement in stain resistance properties. These results are particularly encouraging because of the simplistic nature of the systems prepared and the pentaspiroglycol instantiated caprolactone polymers provide enhancements to polyurethane elastomer formulations relative to the standard formulation, such as standard CAPA® formulations. The enhancements are expected to be more pronounced when the pentaspiroglycol initiated polyol is used in the preparation of systems that are specifically tailored for specific end use properties.

Based upon this evaluation the pentaspiroglycol initiated polyol of the preset disclosure appear to offer all the advantages of a standard CAPA® polyols, which include good hydrolysis resistance, excellent processability with clean, uniform cooks, low cosolvent demand for processing, low cosolvent demand for coalescence, good flexibility and impact resistance, ability to obtain low modulus to medium modulus films, good formulation flexibility (due to lower viscosities), and generally good universal adhesion.

In addition, the pentaspiroglycol initiated polyols of the present disclosure appear to offer the follow advantages over a standard CAPA® polyol: improved chemical resistance and improved hydrolysis resistance is expected.

While several embodiments of the invention of the present disclosure have been shown and described herein, it will be understood that such embodiments are provided by way of example only. Numerous variations, changes and substitutions will occur to those skilled in the art without departing from the spirit of the invention. Rather, the present disclosure is to cover all modifications, equivalents, and alternatives falling within the scope of the present disclosure as defined by the following appended claims and their legal equivalents.

Accordingly, it is intended that the description and appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients can be varied to optimize the desired effects, additional ingredients can be added, and/or similar ingredients can be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

What is claimed is:

1. A polyurethane elastomer comprising a reaction product of:
one or more caprolactone polyol,
one or more isocyanate comprising two or more isocyanate groups, and
optionally one or more chain extender,
wherein the caprolactone polyol is made by a process comprising:
admixing caprolactone monomers and pentaspiroglycol (PSG) to form an initiator-caprolactone mixture or reaction mixture;
adding one or more catalyst to the initiator-caprolactone mixture to form a reaction mixture; and
polymerizing the caprolactone monomers in the reaction mixture, thereby forming the caprolactone polyol.

2. The polyurethane elastomer of claim 1, wherein the process further comprises at least one of: (i) sparing the initiator-caprolactone mixture prior to adding the one or more catalyst; (ii) incubating the initiator-caprolactone mixture prior to adding the one or more catalyst; (iii) heating the initiator-caprolactone mixture to about 70° C. to about 100° C.; (iv) removing excess water from the initiator-caprolactone mixture; or (v) a combination thereof.

3. The polyurethane elastomer of claim 1, wherein polymerizing comprises at least one of (i) performing with refluxing, (ii) performing at about 150° C. to about 190° C., (iii) performing until the caprolactone monomer concentration is below 0.5%, (iv) performing for about 4 to about 6 hours, or (v) a combination thereof.

4. The polyurethane elastomer of claim 1, the process further comprises at least one of: (i) adding one or more acid scavengers; (ii) adding additional catalyst to the reaction mixture, thereby forming the caprolactone polyol; or (iii) a combination thereof.

5. The polyurethane elastomer of claim 1, wherein the initiator-caprolactone mixture further comprises at least one of: one or more antioxidant, one or more stabilizer, or a combination thereof.

6. The polyurethane elastomer of claim 1, wherein at least one of:
the caprolactone monomers are present in an amount of about 65 wt % to about 95 wt % of the initiator-caprolactone mixture;
the pentaspiroglycol (PSG) is present in an amount of about 5 wt % to about 35 wt % of the initiator-caprolactone mixture;
the caprolactone monomers is present in an amount of about 65 wt % to about 95 wt % of the reaction mixture;
the pentaspiroglycol (PSG) is present in an amount of about 5 wt % to about 35 wt % of the reaction mixture;
the one or more catalyst is present in an amount of about 0.001 wt % to about 5 wt % of the reaction mixture;
the one or more antioxidants or stabilizer is present in an amount of up to about 2 wt % of the reaction mixture; or
a combination thereof.

7. The polyurethane elastomer of claim 1, wherein at least one of:
the molecular weight of the caprolactone polyol is about 1,000 g/mol (MW) to about 4500 MW;
the caprolactone polyol comprises less than about 5% caprolactone monomer;
the caprolactone polyol has an acid number of <0.4 KOH/g;
the one or more catalysts is one or more catalyst for ring-opening polymerization; or
a combination thereof.

8. The polyurethane elastomer of claim 1 made by a process comprising reacting:
the one or more caprolactone polyol,
optionally one or more additional polyol, and
the one or more isocyanate comprising two or more isocyanate groups,
thereby forming a polyurethane material.

9. The polyurethane elastomer of claim 8, wherein at least one of:
the process further comprises heating or melting the one or more isocyanate comprising two or more isocyanate groups, optionally under a nitrogen blanket;
the process further comprises heating the one or more caprolactone polyol, optionally the one or more additional polyol, and the one or more isocyanate;
the process further comprises incubating or reacting the one or more caprolactone polyol, optionally the one or more additional polyol, and the one or more isocyanate for at least about 0.5 hours;
the process further comprises degassing the polyurethane material under vacuum;
the polyurethane material has a NCO content of about 3.0% to about 15.0%, such as about 6.0%; or
a combination thereof.

10. The polyurethane elastomer of claim 1, the process further comprising adding to, and/or mixing with, the polyurethane material one or more chain extender, thereby forming the polyurethane elastomer.

11. The polyurethane elastomer of claim 1, wherein at least one of:
the one or more chain extender is added in an amount sufficient to achieve an isocyanate index of about 95 to about 107;
the one or more chain extender has a molecular weight from about 60 g/mol (MW) to about 600 MW;
the one or more chain extender includes or is one or more diol chain extender, one or more diamine chain extender; or
a combination thereof.

12. The polyurethane elastomer of claim 1, the process further comprising molding the polyurethane elastomer.

13. The polyurethane elastomer of claim 12, wherein molding the polyurethane elastomer comprises at least one of:
preheating a mold to about 80° C. to about 120° C.;
adding the polyurethane elastomer to a mold;
applying a releasing agent to a mold prior to adding the polyurethane elastomer;
cure the polyurethane elastomer in a mold at about 80° C. to about 120° C., for about 16 hours, or a combination thereof;
conditioning a mold with the polyurethane elastomer; or
a combination thereof.

14. The polyurethane elastomer of claim 1, wherein at least one of:
the one or more additional polyol includes or is a low-molecular-weight polyol having a number average molecular weight of 400 or less;
the one or more additional polyol has three or more hydroxyl groups;
the one or more isocyanate includes or is at least one of: monomeric, oligomeric, polymeric, or a mixture thereof;
the one or more isocyanate includes or is at least one of: an aliphatic polyisocyante, mono-cyclic polyisocyanate, aromatic polyisocyanates, aromatic/aliphatic polyisocyanate, or a combination thereof; or
a combination thereof.

15. The polyurethane elastomer of claim 1, wherein at least one of:
the one or more additional polyol includes or is at least one of: one or more trihydric alcohol; one or more tetrahydric alcohol; one or more pentahydric alcohol; one or more hexahydric alcohol; one or more heptahydric alcohol; one or more octahydric alcohol; one or more polyalkylene oxide having three or more hydroxyl groups; or a combination thereof;
the one or more isocyanate includes or is at least one of diphenylmethane diisocyanate, isophorone diisocyanate, bimethylene diisocyanate, trimethylene diisocyanate, tetramethylene diisocyanate, pentamethylene diisocyanate, hexamethylene diisocyanate, heptamethylene diisocyanate, toluene diisocyanate, naphthylene diisocyanate, cyclohexylmethane diisocyanate, dicyclohexylmethane diisocyanate, or a mixture thereof;
the one or more chain extender includes or is a diol chain extender that includes or is an aliphatic diol or an aromatic diol;
the one or more diol chain extender includes or is at least one of an alkylene oxide or glycol, ethylene glycol, propanediol, butanediol, pentadiol, hexanediol, heptadiol, dihydroxybenzene, di(hydroxyethyl)-hydroxyquinone, di(hydroxymethyl)-hydroxyquinone, di-(hydroxyethyl)-bisphenol A, or a mixture thereof;
the one or more diamine chain extender includes or is at least one of diaminodiphenylmethane, dichloro-diaminodiphenylmethane, diaminobenzene, dimethoxy-diamino biphenyl, dimethyl-diamino biphenyl, diamino biphenyl, dichloro-diamino biphenyl, or a mixture thereof; or
a combination thereof.

16. The polyurethane elastomer of claim 1, wherein at least one of:
the one or more additional polyol includes or is at least one of: glycerin; 2-methyl-2-hydroxymethyl-1,3-propanediol; 2,4-dihydroxy-3-hydroxymethylpentane; 1,2,6-hexanetriol; trimethylolpropane; 2,2-bis(hydroxymethyl)-3-butanol; tetramethylolmethane (pentaerythritol); diglycerol; xylitol; sorbitol; mannitol; iditol; dulcitol; altritol; inositol; dipentaerythritol; perseitol; sucrose; polyethylenepolyol, polypropylenepolyol, polyethylenepolypropylenepolyol; or a combination thereof;
the one or more isocyanate includes or is at least one of: 1,3-trimethylene diisocyanate; 2,3-trimethylene diisocyanate; 1,2-trimethylene diisocyanate; 2,2-trimethylene diisocyanate; 1,4-tetramethylene diisocyanate; 1,3-tetramethylene diisocyanate; 1,2-tetramethylene diisocyanate; 2,3-tetramethylene diisocyanate; 1,1-tetramethylene diisocyanate; 2,2-tetramethylene diisocyanate; 1,5-pentamethylene diisocyanate; 1,4-pentamethylene diisocyanate; 1,3-pentamethylene diisocyanate; 1,2-pentamethylene diisocyanate; 2,3-pentamethylene diisocyanate; 2,4-pentamethylene diisocyanate; 3,4-pentamethylene diisocyanate; 3,5-pentamethylene diisocyanate; 1,1-pentamethylene diisocyanate; 2,2-pentamethylene diisocyanate; 3,3-pentamethylene diisocyanate; 1,6-hexamethylene diisocyanate; 1,5-hexamethylene diisocyanate; 1,4-hexamethylene diisocyanate; 1,3-hexamethylene diisocyanate; 1,2-hexamethylene diisocyanate; 2,3-hexamethylene diisocyanate; 2,4-hexamethylene diisocyanate; 2,5-hexamethylene diisocyanate; 3,4-hexamethylene diisocyanate; 3,5-hexamethylene diisocyanate; 4,5-hexamethylene diisocyanate; 1,1-hexamethylene diisocyanate; 2,2-hexamethylene diisocyanate; 3,3-hexamethylene diisocyanate; 1,7-heptamethylene diisocyanate; 1,6-heptamethylene diisocyanate; 1,5-heptamethylene diisocyanate; 1,4-heptamethylene diisocyanate; 1,3-heptamethylene diisocyanate; 1,2-heptamethylene diisocyanate; 2,3-heptamethylene diisocyanate; 2,4-heptamethylene diisocyanate; 2,5-heptamethylene diisocyanate; 2,6-heptamethylene diisocyanate; 3,3-heptamethylene diisocyanate; 3,4-heptamethylene diisocyanate; 1,1-heptamethylene diisocyanate; 2,2-heptamethylene diisocyanate; 3,3-heptamethylene diisocyanate; 4,4-heptamethylene diisocyanate; toluene-2,4-diisocyanate; toluene-2,6-diisocyanate; 1,2-naphthylene diisocyanate; 1,3-naphthylene diisocyanate; 1,4-naphthylene diisocyanate; 1,5-naphthylene diisocyanate; 1,6-naphthylene diisocyanate; 1,7-naphthylene diisocyanate; 1,8-naphthylene diisocyanate; 1,4-cyclohexylmethane diisocyanate; 2,4-cyclohexylmethane diisocyanate; 3,4-cyclohexylmethane diisocyanate; 4,4-cyclohexylmethane diisocyanate; 4,4′-dicyclohexylmethane diisocyanate; 1,4-dicyclohexylmethane diisocyanate; or a mixture thereof;
the one or more isocyanate includes or is at least one of: 2,2′-diphenylmethane diisocyanate; 2,4′-diphenylmethane diisocyanate; 4,4′-diphenylmethane diisocyanate (MDI); 3,3′-dimethyl-4,4′-biphenylene diisocyanate (TODI); a toluene diisocyanate (TDI); a polymeric MDI; a modified liquid 4,4′-diphenylmethane diisocyanate; hexamethylene-diisocyanate (“HDI”); 4,4′dicyclohexylmethane diisocyanate (“H₁₂ MDI”); isophorone diisocyanate (“IPDI”); para-phenylene diisocyanate (“PPDI”); meta-phenylene diisocyanate (“MPDI”); tetramethylene diisocyanate; dodecane diisocyanate; octamethylene diisocyanate; decamethylene diisocyanate; cyclobutane-1,3-diisocyanate; 1,2-cyclohexane diisocyanate; 1,3-cyclohexane diisocyanate; 1,4-cyclohexane diisocyanate; 2,4-methylcyclohexane diisocyanate; 2,6-methylcyclohexane diisocyanate; 4,4′-dicyclohexyldiisocyanate; 2,4′-dicyclohexyldiisocyanate; 1,3,5-cyclohexane triisocyanate; a isocyanate-methylcyclohexane isocyanate; a isocyanatoethylcyclohexane isocyanate; a bis(isocyanatomethyl)-cyclohexane diisocyanate; 4,4′-bis(isocyanatomethyl) dicyclohexane; 2,4′-bis(isocyanatomethyl) dicyclohexane; 2,4-hexahydrotoluenediisocyanate; 2,6-hexahydrotoluenediisocyanate; 1,2-phenylene diisocyanate; 1,3-phenylene diisocyanate; 1,4-phenylene diisocyanate; triphenyl methane-4,4′,4″-triisocyanate; naphthylene-1,5-diisocyanate; 2,4′-biphenyl diisocyanate; 4,4′-biphenyl diisocyanate; 2,2-biphenyl diisocyanate; a polyphenyl polymethylene polyisocyanate (“PMDI”); meta-tetramethylxylene diisocyanate (“m-TMXDI”); para-tetramethylxylene diisocyanate (“p-TMXDI”); or a mixture thereof;
the one or more chain extender includes or is one or more diol chain extender that includes or is at least one of: 1,3-propanediol; 1,2-propanediol; 1,1-propanediol; 2,2-propanediol; 1,4-butanediol; 1,3-butanediol; 1,2-butanediol; 2,3-butanediol; 1,1-butanediol; 2,2-butanediol; 1,5-pentadiol; 1,4-pentadiol; 1,3-pentadiol; 1,2-pentadiol; 2,3-pentadiol; 2,4-pentadiol; 3,4-pentadiol; 3,5-hexanediol; 1,1-pentadiol; 2,2-pentadiol; 3,3-pentadiol; 1,6-hexanediol; 1,5-hexanediol; 1,4-hexanediol; 1,3-hexanediol; 1,2-hexanediol; 2,3-hexanediol; 2,4-hexanediol; 2,5-hexanediol; 3,4-hexanediol; 3,5-hexanediol; 4,5-hexanediol; 1,1-hexanediol; 2,2-hexanediol; 3,3-hexanediol; 1,7-heptadiol; 1,6-heptadiol; 1,5-heptadiol; 1,4-heptadiol; 1,3-heptadiol; 1,2-heptadiol; 2,3-heptadiol; 2,4-heptadiol; 2,5-heptadiol; 2,6-heptadiol; 3,3-heptadiol; 3,4-heptadiol; 1,1-heptadiol; 2,2-heptadiol; 3,3-heptadiol; 4,4-heptadiol; 1,2-dihydroxybenzene; 1,3-dihydroxybenzene; 1,4-dihydroxybenzene; 1,4-di-(betahydroxyethyl)-hydroxyquinone; 2,5-di-(hydroxyethyl)-hydroxyquinone; 2,3-di-(hydroxyethyl)-hydroxyquinone; 3,5-di-(hydroxyethyl)-hydroxyquinone; 2,5-di-(hydroxyethyl)-hydroxyquinone; 2,3-di-(hydroxymethyl)-hydroxyquinone; 3,5-di-(hydroxymethyl)-hydroxyquinone; 1,4-di-(betahydroxyethyl)-bisphenol A; 1,3-di-(betahydroxyethyl)-bisphenol A; 1,2-di-(betahydroxyethyl)-bisphenol A; 1,5-di-(betahydroxyethyl)-bisphenol A; 2,3-di-(betahydroxyethyl)-bisphenol A; 2,4-di-(betahydroxyethyl)-bisphenol A; 2,5-di-(betahydroxyethyl)-bisphenol A; 2,6-di-(betahydroxyethyl)-bisphenol A; 3,4-di-(betahydroxyethyl)-bisphenol A; 3,5-di-(betahydroxyethyl)-bisphenol A; or a mixture thereof;
the one or more chain extender includes or is one or more diamine chain extender that includes or is at least one of: 2,2′-diaminodiphenylmethane; 2,3′-diaminodiphenylmethane; 2,4′-diaminodiphenylmethane; 2,5′-diaminodiphenylmethane; 2,6′-diaminodiphenylmethane; 3,4′-diaminodiphenylmethane; 3,5′-diaminodiphenylmethane; 3,6′-diaminodiphenylmethane; 4,4′-diaminodiphenylmethane; 4,5′-diaminodiphenylmethane; 4,6′-diaminodiphenylmethane; 5,6′-diaminodiphenylmethane; 2,2′-dichloro-3,3′-diaminodiphenylmethane; 2,2′-dichloro-4,4′-diaminodiphenylmethane; 5,5′-dichloro-3,3′-diaminodiphenylmethane; 2,2′-dichloro-6,6′-diaminodiphenylmethane; 2,2′-dichloro-3,4′-diaminodiphenylmethane; 2,2′-dichloro-3,5′-diaminodiphenylmethane; 2,2′-dichloro-3,6′-diaminodiphenylmethane; 2,2′-dichloro-4,5′-diaminodiphenylmethane; 2,2′-dichloro-4,6′-diaminodiphenylmethane; 2,2′-dichloro-5,6′-diaminodiphenylmethane; 3,3′-dichloro-2,2′-diaminodiphenylmethane; 3,3′-dichloro-4,4′-diaminodiphenylmethane; 3,3′-dichloro-5,5′-diaminodiphenylmethane; 3,3′-dichloro-6,6′-diaminodiphenylmethane; 3,3′-dichloro-2,5′-diaminodiphenylmethane; 3,3′-dichloro-4,5′-diaminodiphenylmethane; 3,3′-dichloro-6,5′-diaminodiphenylmethane; 3,3′-dichloro-4,2′-diaminodiphenylmethane; 3,3′-dichloro-4,6′-diaminodiphenylmethane; 4,4′-dichloro-2,2′-diaminodiphenylmethane; 4,4′-dichloro-3,3′-diaminodiphenylmethane; 4,4′-dichloro-5,5′-diaminodiphenylmethane; 4,4′-dichloro-6,6′-diaminodiphenylmethane; 4,4′-dichloro-2,3′-diaminodiphenylmethane; 4,4′-dichloro-2,5′-diaminodiphenylmethane; 4,4′-dichloro-2,6′-diaminodiphenylmethane; 4,4′-dichloro-3,5′-diaminodiphenylmethane; 4,4′-dichloro-3,6′-diaminodiphenylmethane; 4,4′-dichloro-5,6′-diaminodiphenylmethane; 5,5′-dichloro-2,2′-diaminodiphenylmethane; 5,5′-dichloro-3,3′-diaminodiphenylmethane; 5,5′-dichloro-4,4′-diaminodiphenylmethane; 5,5′-dichloro-6,6′-diaminodiphenylmethane; 5,5′-dichloro-2,3′-diaminodiphenylmethane; 5,5′-dichloro-2,4′-diaminodiphenylmethane; 5,5′-dichloro-2,6′-diaminodiphenylmethane; 5,5′-dichloro-3,4′-diaminodiphenylmethane; 5,5′-dichloro-3,6′-diaminodiphenylmethane; 5,5′-dichloro-4,6′-diaminodiphenylmethane; 6,6′-dichloro-2,2′-diaminodiphenylmethane; 6,6′-dichloro-3,3′-diaminodiphenylmethane; 6,6′-dichloro-4,4′-diaminodiphenylmethane; 6,6′-dichloro-5,5′-diaminodiphenylmethane; 6,6′-dichloro-2,3′-diaminodiphenylmethane; 6,6′-dichloro-2,4′-diaminodiphenylmethane; 6,6′-dichloro-2,5′-diaminodiphenylmethane; 6,6′-dichloro-3,4′-diaminodiphenylmethane; 6,6′-dichloro-3,5′-diaminodiphenylmethane; 6,6′-dichloro-4,5′-diaminodiphenylmethane; 1,4-diaminobenzene; 1,2-diaminobenzene; 1,3-diaminobenzene; 2,2′-dimethoxy-3,3′-diamino biphenyl; 2,2′-dimethoxy-4,4′-diamino biphenyl; 5,5′-dimethoxy-3,3′-diamino biphenyl; 2,2′-dimethoxy-6,6′-diamino biphenyl; 2,2′-dimethoxy-3,4′-diamino biphenyl; 2,2′-dimethoxy-3,5′-diamino biphenyl; 2,2′-dimethoxy-3,6′-diamino biphenyl; 2,2′-dimethoxy-4,5′-diamino biphenyl; 2,2′-dimethoxy-4,6′-diamino biphenyl; 2,2′-dimethoxy-5,6′-diamino biphenyl; 3,3′-dimethoxy-2,2′-diamino biphenyl; 3,3′-dimethoxy-4,4-diamino biphenyl; 3,3′-dimethoxy-5,5′-diamino biphenyl; 3,3′-dimethoxy-6,6′-diamino biphenyl; 3,3′-dimethoxy-2,5′-diamino biphenyl; 3,3′-dimethoxy-4,5′-diamino biphenyl; 3,3′-dimethoxy-6,5′-diamino biphenyl; 3,3′-dimethoxy-4,2′-diamino biphenyl; 3,3′-dimethoxy-4,6′-diamino biphenyl; 4,4′-dimethoxy-2,2′-diamino biphenyl; 4,4′-dimethoxy-3,3′-diamino biphenyl; 4,4′-dimethoxy-5,5′-diamino biphenyl; 4,4′-diamino biphenyl; 4,4′-dimethoxy-2,6′-diamino biphenyl; 4,4′-dimethoxy-3,5′-diamino biphenyl; 4,4′-dimethoxy-3,6′-diamino biphenyl; 4,4′-dimethoxy-5,6′-diamino biphenyl; 5,5′-dimethoxy-2,2′-diamino biphenyl; 5,5′-dimethoxy-3,3′-diamino biphenyl; 5,5′-dimethoxy-4,4′-diamino biphenyl; 5,5′-dimethoxy-6,6′-diamino biphenyl; 5,5′-dimethoxy-2,3′-diamino biphenyl; 5,5′-dimethoxy-2,4′-diamino biphenyl; 5,5′-dimethoxy-2,6′-diamino biphenyl; 5,5′-dimethoxy-3,4′-diamino biphenyl; 5,5′-dimethoxy-3,6′-diamino biphenyl; 5,5′-dimethoxy-4,6′-diamino biphenyl; 6,6′-dimethoxy-2,2′-diamino biphenyl; 6,6′-dimethoxy-3,3′-diamino biphenyl; 6,6′-dimethoxy-4,4′-diamino biphenyl; 6,6′-dimethoxy-5,5′-diamino biphenyl; 6,6′-dimethoxy-2,3′-diamino biphenyl; 6,6′-dimethoxy-2,4′-diamino biphenyl; 6,6′-dimethoxy-2,5′-diamino biphenyl; 6,6′-dimethoxy-3,4′-diamino biphenyl; 6,6′-dimethoxy-3,5′-diamino biphenyl; 6,6′-dimethoxy-4,5′-diamino biphenyl; 2,2′-dimethyl-3,3′-diamino biphenyl; 2,2′-dimethyl-4,4′-diamino biphenyl; 5,5′-dimethyl-3,3′-diamino biphenyl; 2,2′-dimethyl-6,6′-diamino biphenyl; 2,2′-dimethyl-3,4′-diamino biphenyl; 2,2′-dimethyl-3,5′-diamino biphenyl; 2,2′-dimethyl-3,6′-diamino biphenyl; 2,2′-dimethyl-4,5′-diamino biphenyl; 2,2′-dimethyl-4,6′-diamino biphenyl; 2,2′-dimethyl-5,6′-diamino biphenyl; 3,3′-dimethyl-2,2′-diamino biphenyl; 3,3′-dimethyl-4,4-diamino biphenyl; 3,3′-dimethyl-5,5′-diamino biphenyl; 3,3′-dimethyl-6,6′-diamino biphenyl; 3,3′-dimethyl-2,5′-diamino biphenyl; 3,3′-dimethyl-4,5′-diamino biphenyl; 3,3′-dimethyl-6,5′-diamino biphenyl; 3,3′-dimethyl-4,2′-diamino biphenyl; 3,3′-dimethyl-4,6′-diamino biphenyl; 4,4′-dimethyl-2,2′-diamino biphenyl; 4,4′-dimethyl-3,3′-diamino biphenyl; 4,4′-dimethyl-5,5′-diamino biphenyl; 4,4′-dimethyl-6,6′-diamino biphenyl; 4,4′-dimethyl-2,3′-diamino biphenyl; 4,4′-dimethyl-2,5′-diamino biphenyl; 4,4′-dimethyl-2,6′-diamino biphenyl; 4,4′-dimethyl-3,5′-diamino biphenyl; 4,4′-dimethyl-3,6′-diamino biphenyl; 4,4′-dimethyl-5,6′-diamino biphenyl; 5,5′-dimethyl-2,2′-diamino biphenyl; 5,5′-dimethyl-3,3′-diamino biphenyl; 5,5′-dimethyl-4,4′-diamino biphenyl; 5,5′-dimethyl-6,6′-diamino biphenyl; 5,5′-dimethyl-2,3′-diamino biphenyl; 5,5′-dimethyl-2,4′-diamino biphenyl; 5,5′-dimethyl-2,6′-diamino biphenyl; 5,5′-dimethyl-3,4′-diamino biphenyl; 5,5′-dimethyl-3,6′-diamino biphenyl; 5,5′-dimethyl-4,6′-diamino biphenyl; 6,6′-dimethyl-2,2′-diamino biphenyl; 6,6′-dimethyl-3,3′-diamino biphenyl; 6,6′-dimethyl-4,4′-diamino biphenyl; 6,6′-dimethyl-5,5′-diamino biphenyl; 6,6′-dimethyl-2,3′-diamino biphenyl; 6,6′-dimethyl-2,4′-diamino biphenyl; 6,6′-dimethyl-2,5′-diamino biphenyl; 6,6′-dimethyl-3,4′-diamino biphenyl; 6,6′-dimethyl-3,5′-diamino biphenyl; 6,6′-dimethyl-4,5′-diamino biphenyl; 2,2′-diamino biphenyl; 2,3′-diamino biphenyl; 2,4′-diamino biphenyl; 2,5′-diamino biphenyl; 2,6′-diamino biphenyl; 3,4′-diamino biphenyl; 3,5′-diamino biphenyl; 3,6′-diamino biphenyl; 4,4′-diamino biphenyl; 4,5′-diamino biphenyl; 4,6′-diamino biphenyl; 5,6′-diamino biphenyl; 2,2′-dichloro-3,3′-diamino biphenyl; 2,2′-dichloro-4,4′-diamino biphenyl; 5,5′-dichloro-3,3′-diamino biphenyl; 2,2′-dichloro-6,6′-diamino biphenyl; 2,2′-dichloro-3,4′-diamino biphenyl; 2,2′-dichloro-3,5′-diamino biphenyl; 2,2′-dichloro-3,6′-diamino biphenyl; 2,2′-dichloro-4,5′-diamino biphenyl; 2,2′-dichloro-4,6′-diamino biphenyl; 2,2′-dichloro-5,6′-diamino biphenyl; 3,3′-dichloro-2,2′-diamino biphenyl; 3,3′-dichloro-4,4′-diamino biphenyl; 3,3′-dichloro-5,5′-diamino biphenyl; 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl; 4,4′-dichloro-2,2′-diamino biphenyl; 4,4′-dichloro-3,3′-diamino biphenyl; 4,4′-dichloro-5,5′-diamino biphenyl; 4,4′-dichloro-6,6′-diamino biphenyl; 4,4′-dichloro-2,3′-diamino biphenyl; 4,4′-dichloro-2,5′-diamino biphenyl; 4,4′-dichloro-2,6′-diamino biphenyl; 4,4′-dichloro-3,5′-diamino biphenyl; 4,4′-dichloro-3,6′-diamino biphenyl; 4,4′-dichloro-5,6′-diamino biphenyl; 5,5′-dichloro-2,2′-diamino biphenyl; 5,5′-dichloro-3,3′-diamino biphenyl; 5,5′-dichloro-4,4′-diamino biphenyl; 5,5′-dichloro-6,6′-diamino biphenyl; 5,5′-dichloro-2,3′-diamino biphenyl; 5,5′-dichloro-2,4′-diamino biphenyl; 5,5′-dichloro-2,6′-diamino biphenyl; 5,5′-dichloro-3,4′-diamino biphenyl; 5,5′-dichloro-3,6′-diamino biphenyl; 5,5′-dichloro-4,6′-diamino biphenyl; 6,6′-dichloro-2,2′-diamino biphenyl; 6,6′-dichloro-3,3′-diamino biphenyl; 6,6′-dichloro-4,4′-diamino biphenyl; 6,6′-dichloro-5,5′-diamino biphenyl; 6,6′-dichloro-2,3′-diamino biphenyl; 6,6′-dichloro-2,4′-diamino biphenyl; 6,6′-dichloro-2,5′-diamino biphenyl; 6,6′-dichloro-3,4′-diamino biphenyl; 6,6′-dichloro-3,5′-diamino biphenyl; 6,6′-dichloro-4,5′-diamino biphenyl; or a mixture thereof; or
a combination thereof.

17. The polyurethane elastomer of claim 1, wherein at least one of:
the one or more additional polyol includes or is at least one of: N-butanol; ethylene glycol; 1,2-propanediol; 1,3-butanediol; 1,4-butanediol; 2,3-butanediol; 1,5-pentanediol; 1,6-hexanediol; neopentyl glycol; 1,4-dihydroxycyclohexane; 1,4-dimethylolcyclohexane; 1,8-octanediol; 1,10-decanediol; 1,12-dodecanediol; 1,4-cyclohexanediol; 1,4-cyclohexanedimethanol; N-substituted ethanolamine; glycerol; trimethylolpropane; trimethylolethane; pentaerythritol; or a combination thereof;
the one or more isocyanate includes or is at least one of: 4,4′-diphenylmethane diisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof;
the one or more chain extender includes or is at least one of: diethylene triamine (DETA), ethylene diamine (EDA), meta-xylylenediamine (MXDA), aminoethyl ethanolamine (AEEA), 2-methyl pentane diamine, propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, hydrazine, substituted hydrazine, hydrazine reaction products, or a combination thereof; or
a combination thereof.

18. The polyurethane elastomer of claim 1, wherein at least one of:
the one or more isocyanate includes or is 4,4′-diisocyanate dicyclohexylmethane;
the one or more chain extender includes or is 1,4-butanediol; or
a combination thereof.

19. The polyurethane elastomer of claim 1, wherein at least one of:
the polyurethane elastomer comprises a hardness of Shore Hardness A 25 to Shore Hardness of D 75;
the polyurethane elastomer has a hard segment fraction is about 0.20 to about 0.50; or
a combination thereof.

20. A method of making the polyurethane elastomer of claim 1, the method comprising reacting:
one or more caprolactone polyol,
optionally one or more additional polyol, and
one or more (e.g., 1, 2, 3, 4, 5, or more) isocyanate comprising two or more isocyanate groups,
thereby forming a polyurethane material.

21. The method of claim 20, further comprising adding to, and/or mixing with, the polyurethane material one or more chain extender.

22. The method of claim 20, further comprising molding the polyurethane elastomer.

23. An article comprising, or produced from, the polyurethane elastomer of claim 1.
